(19) United States
(12) Patent Application Publication
(10) Pub. No.: US 2007/0038889 A1
(43) Pub. Date: Feb. 15, 2007

(54) Methods and systems to access process control log information associated with process control systems

(76) Inventors: Robert Daniel Wiggins, Round Rock, TX (US); Aaron Christopher Jones, Round Rock, TX (US); William George Irwin, Austin, TX (US); Cindy Alsup Scott, Georgetown, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/202,312

(22) Filed: Aug. 11, 2005

(51) Int. Cl. G06F 11/00

(52) U.S. Cl. 714/20

(57) ABSTRACT

Methods, apparatus, and articles of manufacture to access process control log information associated with process control systems involve obtaining the process control log information from a database based on a plurality of logging time periods and at least one data query. The process control log information is then categorized based on at least one of a plurality of categories. A plurality of output files are then generated based on the plurality of logging time periods and the categorized process control log information. A portion of the process control log information is then retrieved from one of the plurality of output files based on one of the plurality of logging time periods and the portion of the process control log information is output.

### FIELD OF THE DISCLOSURE

The present disclosure relates generally to processor control systems and, more particularly, to process control methods and systems to access process control log information associated with process control systems.

### BACKGROUND

Process control systems, like those used in chemical, petroleum or other processes, typically include one or more centralized process controllers communicatively coupled to at least one host or operator workstation and to one or more field devices via analog, digital or combined analog/digital buses. The field devices, which may be, for example, valves, valve positioners, switches and transmitters (e.g., temperature, pressure and flow rate sensors), perform functions within the process such as opening or closing valves and measuring process parameters. The process controller receives signals indicative of process measurements made by the field devices and/or other information pertaining to the field devices, uses this information to implement a control routine, and then generates control signals that are sent over the buses or other communication lines to the field devices to control the operation of the process. Information from the field devices and the controllers may be made available to one or more applications executed by the operator workstation to enable an operator to perform desired functions with respect to the process, such as viewing the current state of the process, modifying the operation of the process, etc.

Process control system applications typically include process control monitoring routines that can be configured to monitor various aspects of a process control system and log information associated with monitoring the process control system. For example, monitoring routines are often used to monitor alarms associated with various field devices, modules, plant areas, etc. and collect detailed information (e.g., instance/condition counts, time of day, acknowledged/unacknowledged status, duration, etc.) associated with the alarms. Monitoring routines may also be used to monitor other aspects of a process control system such as, for example, events, actions, errors, etc. The collected detailed information (i.e., process control log information) is typically stored in a database. As time passes more process control log information is generated and stored, thus, increasing the size of the database.

To analyze the performance or other operational aspects of a process control system, users retrieve the process control log information from the database using, for example, data queries. As the amount of data stored in the database increases, the access times associated with retrieving process control log information also increases. Each access to the database may require several minutes to return the requested process control log information. The long access times associated with retrieving process control log information often decrease productivity and decrease the efficiency of analyzing the process control log information, thus, delaying the successfully identification of potential problems and repairs or upgrades associated with a process control system. In turn, the decreased productivity and the decreased efficiency of performing analyses can increase a company's operational costs and reduce its process yields.

### SUMMARY

Example methods and systems to access process control log information associated with process control systems are disclosed herein. In accordance with one example, a method of accessing process control log information involves obtaining the process control log information from a database based on a plurality of logging time periods and at least one data query. The process control log information is then categorized based on at least one of a plurality of categories. A plurality of output files are then generated based on the plurality of logging time periods and the categorized process control log information. A portion of the process control log information is then retrieved from one of the plurality of output files based on one of the plurality of logging time periods and is output.

In accordance with an example method of generating web browser session history disclosed herein, a first index value is assigned to a first web page. A request associated with loading a second web page is then obtained and the first index value is incremented. Changed information associated with the first web page is then stored in a table based on the first index value and a second index value is assigned to the second web page.

In accordance with an example method of generating a bookmark for a dynamic web page disclosed herein, a web page displaying first information is identified. Second information provided to a web application via the web page and associated with displaying third information via the web page is then obtained. The second information is then stored in a database.

### BRIEF DESCRIPTION OF THE DRAWINGS

FIG. 1 is a block diagram illustrating an example process control system network.

FIG. 2 is a block diagram of an example system that may be used to generate optimized storage format data files and retrieve process control log information from the optimized storage format data files.

FIG. 3 depicts an example format for a daily optimized storage format data file.

FIG. 4 depicts a portion of an example format for a monthly optimized storage format data file.

FIG. 5 is a legend having a plurality of data descriptions associated with tags used to organize process control log information in optimized storage format data files.

FIG. 6 is another legend having a plurality of data category descriptions associated with table name tags used to organize process control log information in optimized storage format data files.

FIGS. 7A and 7B depict an example daily optimized storage format data file.

FIGS. 8A and 8B depict an example monthly optimized storage format data file.

FIG. 9 is an example web-based user interface that may be used to access process control log information from the example optimized storage format data files of FIGS. 7A, 7B, 8A, and 8B.

FIGS. 10A and 10B depict a portion of the example web-based user interface of FIG. 9 used to display detailed information associated with a selected type of process control log information.

FIG. 11 depicts an example web application configured to generate bookmarks associated with web pages having dynamic information.

FIG. 12 depicts the example web application of FIG. 11 configured to generate web page histories used to maintain changed data field values during backward and forward navigation of web pages.

FIG. 13 is a flowchart illustrating an example method that may be used to generate optimized storage format data files, access process control log information in the optimized storage format data files, and navigate through the process control log information using a web-based user interface.

FIG. 14 is a flowchart illustrating an example method that may be used to generate an optimized storage format data file.

FIG. 15 is a flowchart illustrating an example method that may be used to retrieve user-requested process control log information from an optimized storage format data file.

FIGS. 16A and 16B depict a flowchart illustrating an example method that may be used to navigate through process control log information using a web-based user interface.

FIG. 17 is a flowchart illustrating an example method that may be used to create a bookmark associated with web pages having dynamic information.

FIG. 18 is a flowchart illustrating an example method that may be used to re-create a web page having dynamic information from a bookmark created using the example method of FIG. 17.

FIG. 19 is a block diagram of an example processor system that may be used to implement the example systems and methods described herein.

### DETAILED DESCRIPTION

Although the following discloses example systems including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the following describes example systems, persons of ordinary skill in the art will readily appreciate that the examples provided are not the only way to implement such systems.

In contrast to known systems that require users (e.g., system engineers) to retrieve process control log information using database accesses associated with relatively long access times, the example methods and systems described herein may be used to store process control log information in optimized storage format (OSF) files from which users can access the process control log information in relatively less time than is typically required to retrieve the process control log information from a database. Process control applications typically include monitoring routines configured to monitor various aspects of one or more distributed process control systems such as, for example, alarms, events, actions, etc. The process control log information may include instance or condition counts (e.g., the number of times an alarm/event/action/etc. instance or condition occurred), a time of day for each instance or condition (e.g., timestamps), whether a particular alarm/event was acknowledged or unacknowledged, the duration of an alarm, summary information, or any other type of data associated with the monitored aspects of the process control system(s). An instance or a condition is associated with the occurrence of an error, an alarm, an event, a user action, etc. that may be associated with performance conditions, operations, process areas, etc. of a process control system. Conditions may be described using various condition levels such as, for example, a critical condition level, a warning condition level, or an advisory condition level. The monitoring routines collect the process control log information and store the process control log information in a log database.

An example system described herein can be configured to periodically communicate one or more data queries to a log database to retrieve process control log information and store the retrieved process control log information in an OSF data file. The process control log information may be stored in the OSF data file in extensible markup language (XML) or in any other suitable data language. The one or more data queries used to retrieve the process control log information from the log database may specify the process control log information to be retrieved based on data logging time periods and data types. The data types may be those that users are typically interested in analyzing. In this manner, a base data query string can be generated once and used a plurality of times thereafter to periodically retrieve the process control log information and generate the OSF data files. After the OSF data files are generated, the process control information can be retrieved from the OSF data files in response to user requests without needing to access the log database, thus, decreasing the amount of time required for a user to retrieve process control information.

To further decrease access times associated with retrieving process control log information, the example system may organize the process control log information based on data monitoring time periods (i.e., data logging time periods), data types (e.g., alarms, user actions, system events, module errors, log alarms, log events, etc.), process control system areas, etc. In this manner, the example system may access an OSF data file and/or a portion of an OSF data file associated with the user-requested information and/or data logging time period to retrieve the user-requested process control log information without needing to search through every record of a log database.

The example system described below is configured to generate daily OSF data files and monthly OSF data files. The daily OSF data files include detailed process control log information describing each occurrence of an instance or a condition associated with, for example, an alarm, event, action, error, etc. A monthly OSF data file includes summarized process control log information of instance/condition occurrences logged during a month. For example, the summarized process control log information in a monthly OSF data file may include total counts associated with the number of times that particular instances or conditions associated with each data type occurred in a month. In this manner, a user may view the summary process control log information retrieved from the monthly OSF data files and determine based on the summary information which detailed process control log information warrants further analysis and, thus, should be retrieved from the daily OSF data files.

A user may access the process control log information using a client program application (e.g., a Microsoft Windows® application) or a web-based application (e.g., a server-side web application, active server pages applications, java servlet applications, a hypertext preprocessor (“PHP”) application, etc.). The client program application may be installed on a processor system used to store the OSF data files or on any other processor system that is communicatively coupled via, for example, a network, to a memory on which the OSF data files are stored. A user may use a web-based application via any web browser capable of communicating with a web host associated with the web-based application and capable of accessing the OSF data files. Web pages associated with web-based applications are typically dynamic, which limits web browsing features available for users to navigate through information in the dynamic web pages. For example, bookmarking a dynamic web page (e.g., creating a favorites link to a dynamic web page) and subsequently using the bookmark to access the dynamic web page often results in generating a blank web page or a web page having different information than the information displayed in the web page at the time the bookmark was generated. Example methods described herein may be used to configure web applications (i.e., web-based applications) to provide users with tools such as bookmarking (e.g., creating favorites links) and forward/backward navigation operations that function in connection with dynamic web pages.

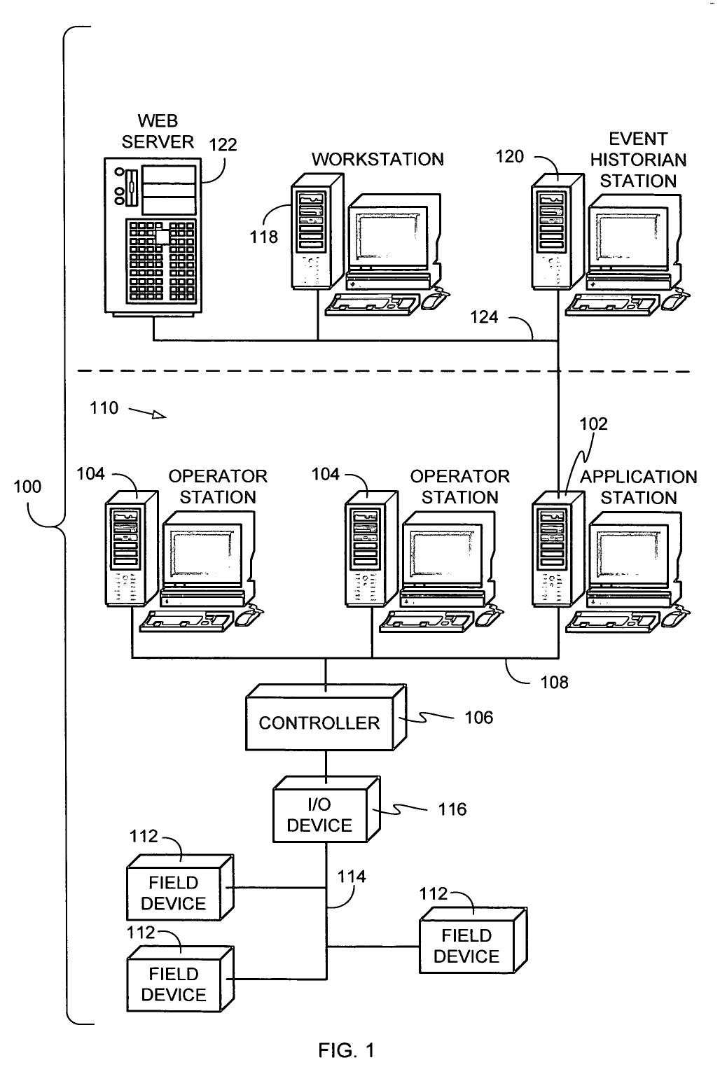

Now turning to FIG. 1, an example enterprise 100 that may be used to implement the example methods and systems described herein includes an application station 102, operator stations 104, and a controller 106, all of which may be communicatively coupled via a bus or local area network (LAN) 108, which is commonly referred to as an application control network (ACN). As shown in FIG. 1, the application station 102, the operator stations 104, the controller 106, and the LAN 108 comprise an example process control system 110. Although one process control system is illustrated, the example enterprise 100 may include any number of distributed process control systems. The LAN 108 may be implemented using any desired communication medium and protocol. For example, the LAN 108 may be based on a hardwired or wireless Ethernet communication scheme, which is well known and, thus, is not described in greater detail herein. However, as will be readily appreciated by those having ordinary skill in the art, any other suitable communication medium and protocol could be used. Further, although a single LAN is shown, more than one LAN and appropriate communication hardware within the application station 102 and the operator stations 104 may be used to provide redundant communication paths between these systems.

The application station 102 may be configured to perform operations associated with one or more information technology applications, user-interactive applications, and/or communication applications. For example, the application station 102 may be configured to perform operations associated with process control-related applications and communication applications that enable the application station 102, the operator stations 104, and the controller 106 to communicate with other devices or systems using any desired communication media (e.g., wireless, hardwired, etc.) and protocols (e.g., HTTP, SOAP, etc.).

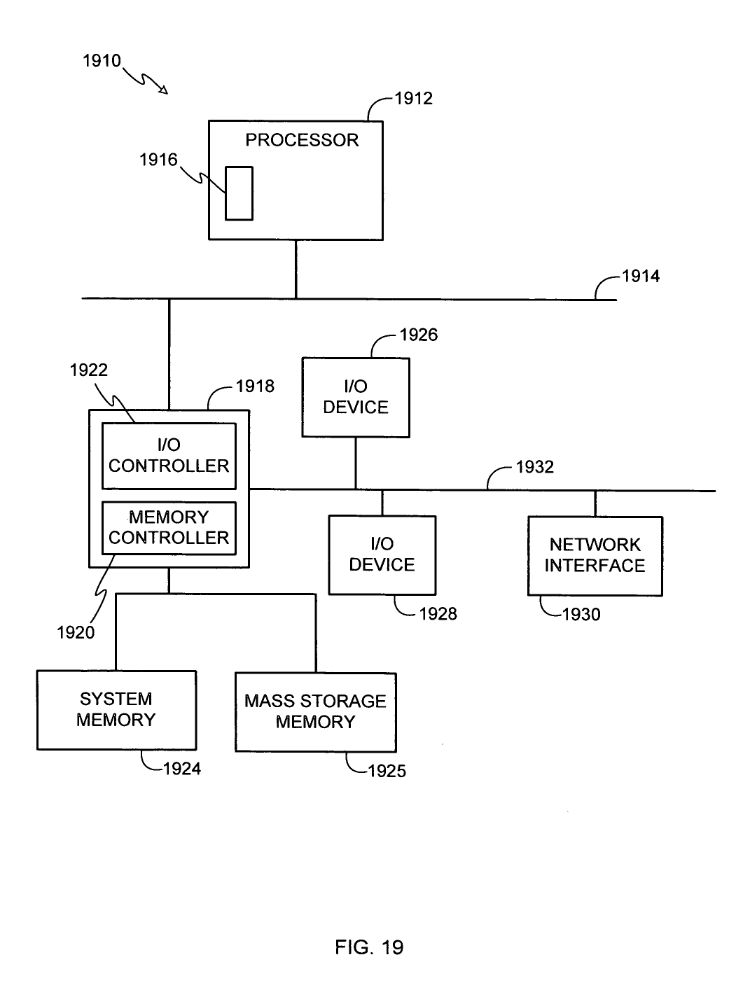

The application station 102 may also be configured to perform operations associated with one or more application(s) used to implement the example methods and systems described herein to periodically retrieve process control log information from a log database, generate OSF data files based on the retrieved process control log information, and output at least portions of the process control log information from the OSF data files in response to user requests. The application station 102 and the operator stations 104 may be implemented using one or more workstations or any other suitable computer systems or processing systems (e.g., the processor system 1910 of FIG. 19). For example, the application station 102 and the operator stations 104 could be implemented using single processor personal computers, single or multi-processor workstations, etc.

The controller 106 may be coupled to a plurality of field devices 112 via a digital data bus 114 and an input/output (I/O) device 116. The field devices 112 may be Fieldbus compliant valves, actuators, sensors, etc., in which case the field devices 112 communicate via the digital data bus 114 using the well-known Fieldbus protocol. Of course, other types of field devices and communication protocols could be used instead. For example, the field devices 112 could instead be Profibus or HART compliant devices that communicate via the data bus 114 using the well-known Profibus and HART communication protocols. Additional I/O devices (similar or identical to the I/O device 116) may be coupled to the controller 106 to enable additional groups of field devices, which may be Fieldbus devices, HART devices, etc., to communicate with the controller 106.

The controller 106 may be, for example, a DeltaV™ controller sold by Fisher-Rosemount Systems, Inc. However, any other controller could be used instead. Further, while only one controller is shown in FIG. 1, additional controllers of any desired type or combination of types could be coupled to the LAN 108. In any case, the controller 106 may perform one or more process control routines that have been generated by a system engineer or other system operator using the application station 102, the operator stations 104, or any workstation and which have been downloaded to and instantiated in the controller 106.

As depicted in FIG. 1, the process control system network also includes a workstation 118, an event historian station 120, and a web server 122, all of which are communicatively coupled to one another and to the application station 102 via another LAN 124. Of course, the workstation 118, the event historian 120, and the web server 122 are also communicatively coupled to the operator stations 104 and the controller 106 via the application station 102 and the LAN 108. The workstation 118 may be configured to perform enterprise-level or plant-wide functions. The workstation 118 may be associated with another process control system network (not shown) and configured to perform primarily process control functions, one or more communication functions, etc. In addition, the workstation 118 may be geographically remotely located, in which case the workstation may be communicatively coupled to the LAN 124 via a wide area network (WAN) that is implemented using, for example, a wireless communication link, an Internet-based or other switched packet-based communication network, telephone lines (e.g., digital subscriber lines), or any combination thereof.

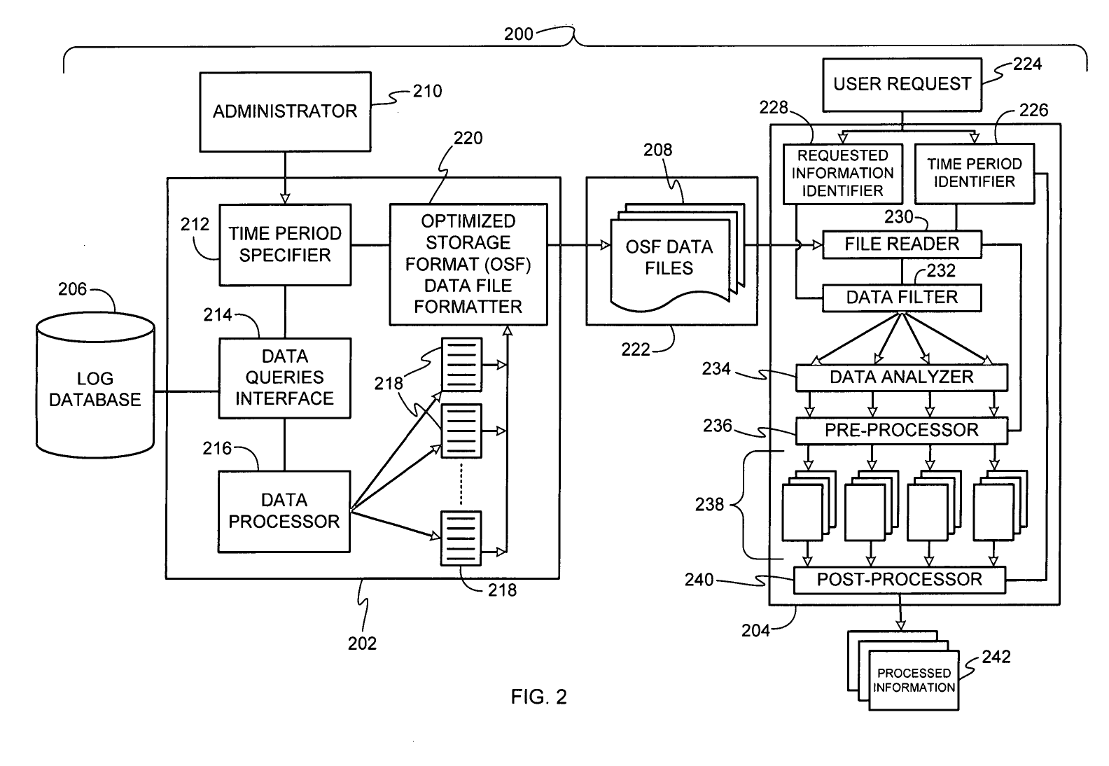

The event historian station 120 may be configured to perform operations associated with one or more monitoring routines to monitor various aspects and/or areas associated with one or more distributed process control systems (e.g., the example process control system 110) of the example enterprise 100. The event historian station 120 may acquire or collect process control log information associated with each event, alarm, action, etc. that the event historian station 120 is configured to monitor. The event historian station 120 may store the process control log information in a log database (e.g., the log database 206 of FIG. 2). For example, the process control log information may be stored in a plurality of log entries in the log database. Each log entry includes detailed information (e.g., timestamps, source names, area names, unit names, or any other descriptive information) associated with an instance or a condition (of an alarm, event, action, etc.) associated with that log entry. The log database may be stored in the event historian station 120 or in any other processor system communicatively coupled to the event historian station 120. The web server 124 may be used to provide web-based content to intranet and/or internet-accessible web pages some of which include process control log information from OSF data files.

The example enterprise 100 is provided to illustrate one type of system within which the example systems and methods described in greater detail below may be advantageously employed. However, the example systems and methods described herein may, if desired, be advantageously employed in other systems of greater or less complexity than the example enterprise 100 shown in FIG. 1 and/or systems that are used in connection with process control activities, enterprise management activities, communication activities, etc.

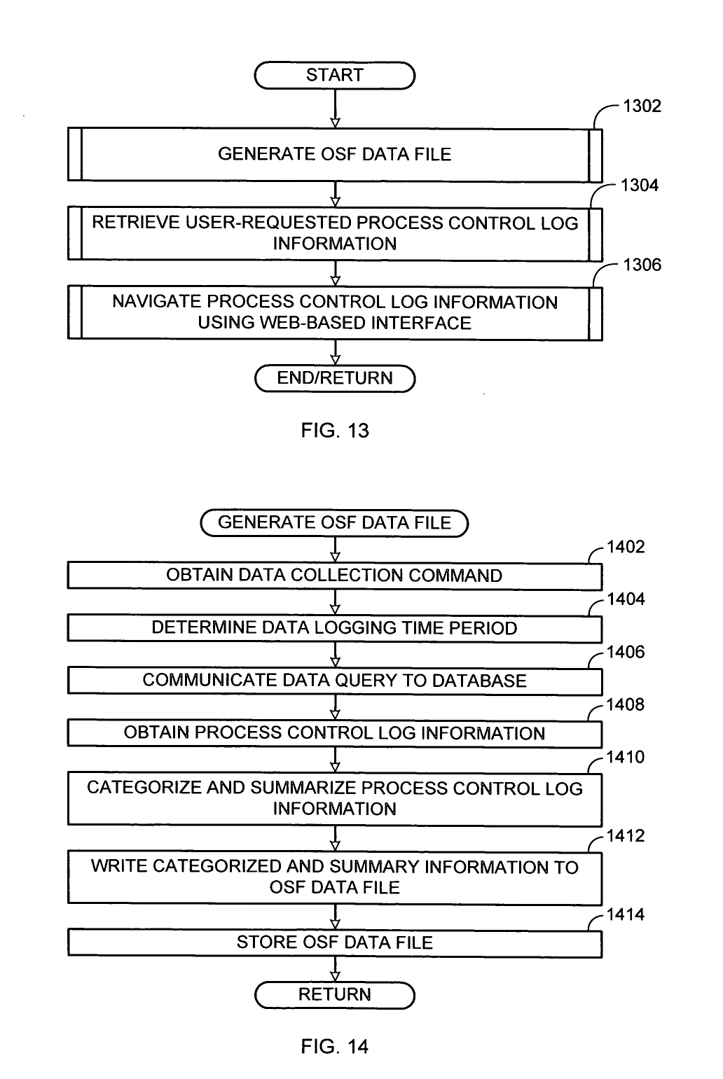

FIG. 2 is a block diagram of an example system 200 that may be used to generate OSF data files and access process control log information. The example structures shown in FIG. 2 may be implemented using any desired combination of hardware and/or software. For example, one or more integrated circuits, discrete semiconductor components, or passive electronic components may be used. Additionally or alternatively, some or all, or parts thereof, of the example structures of FIG. 2 may be implemented using instructions, code, or other software and/or firmware, etc. stored on a computer-readable medium that, when executed by, for example, a processor system (e.g., the processor system 1910 of FIG. 19), perform the methods described herein. Further, the example methods described below in connection with FIGS. 13-15 describe example operations or processes that may be used to implement some or all of the functions or operations associated with the structures shown in FIG. 2.

The example system 200 includes an OSF data file generator 202 and an OSF data file interface 204. In general, the OSF data file generator 202 is configured to retrieve process control log information from a log database 206 based on data queries and store the process control log information in a plurality of OSF data files 208 (e.g., a plurality of output files) based on data logging time periods and data type categories, and the OSF data file interface 204 is configured to retrieve the process control log information from the OSF data files 208 and filter, organize, and output the process control log information in response to user requests. The OSF data file generator 202 and the OSF data file interface 204 may be implemented using the same or separate software applications installed on any processor system that is used to store the log database 206 or that is otherwise communicatively coupled to the log database 206. For example, the OSF data file generator 202 may be implemented in software installed in the event historian station 120 and the OSF data file interface 204 may be implemented in software installed in the application station 102 of FIG. 1.

The OSF data file interface 204 may be configured to communicate with one or more user interfaces. For example, the OSF data file interface 204 may be communicatively coupled with a client application user interface associated with an executable client application (e.g., a Microsoft Windows® application) installed on any processor system that is communicatively coupled to the OSF data file interface 204. Additionally or alternatively, the OSF data file interface 204 may be communicatively coupled with a web-based application user interface. In this case, the web-based application may be configured to exchange information with the OSF data file interface 204 via the web server 122 (FIG. 1) to generate static and/or dynamic web pages to display user-requested process control log information.

Turning in detail to the OSF data file generator 202, an administrator 210 is communicatively coupled to the OSF data file generator 202 and configured to periodically communicate a data collection request or data collection command to the OSF data file generator 202. For example, the administrator 210 may be configured to communicate the data collection command to the OSF data file generator 202 once per day or a plurality of times per day. The data collection command causes the OSF data file generator 202 to perform a data collection process to retrieve process control log information from the log database 206 and write the process control log information to the OSF data files 208. The administrator 202 may be any application or routine that may be configured to communicate data collection commands to the OSF data file generator 202 based on, for example, a schedule or one or more particular time intervals. The administrator 202 may be communicatively coupled to a user interface (e.g., a web-based user interface) via which a user may define or specify the schedule or time interval(s) associated with communicating data collection commands to the OSF data file generator 202. The user may also specify via the user interface data logging time periods to be communicated to the OSF data file generator 202 via the data collection commands.

As shown, the OSF data file generator 202 includes a time period specifier 212 communicatively coupled to the administrator 210. The time period specifier 212 is configured to receive the data collection command from the administrator 210 and determine a data logging time period (e.g., one or more hours, one or more days, one or more weeks, one or more months, etc.) for which the OSF data file generator 202 should retrieve process control log information from the log database 206. The OSF data file generator 202 may also use data logging time periods to determine the data logging time periods for which to generate the OSF data files 208. For example, if the data logging time period is one day, then the OSF data file generator 202 retrieves process control log information logged during the past twenty-four hours, generates a daily OSF data file, and stores the retrieved process control log information in the daily OSF data file. If the data logging time period is one month, the OSF data file generator 202 retrieves process control log information logged during the past month, generates a monthly OSF data file, and stores the retrieved process control log information in the monthly OSF data file.

Additionally or alternatively, in an example implementation in which the administrator 210 communicates a plurality of data collection commands to the time period specifier 212 in one day, the time period specifier 212 may specify a time offset and a data logging time period. In this case, the time offset defines the hours, minutes, seconds, etc. past, for example, midnight, at which the OSF data file generator 202 previously collected process control log information from the log database 206. The time offset configures or instructs the OSF data file generator 202 to retrieve process control log information from the log database 206 that has been logged since the last received data collection command received from the administrator 210. In this manner, the OSF data file generator 202 retrieves only the process control log information that it has not been previously retrieved. Of course, the time period specifier 212 and/or other structures of the OSF data file generator 202 may be configured to employ other suitable methods to substantially eliminate storing duplicate data in the OSF data files 208 or omitting data from the OSF data files 208. For example, if the time period specifier 212 obtains a plurality of data collection commands from the administrator 210 per day, the time period specifier 212 may specify a data logging time period associated with collecting all of the process control log information logged since 12:00 am of that day. In this manner, process control log information previously retrieved form the log database 206 and stored in one of the OSF data files 208 is replaced or overwritten with the same process control log information and any additional process control log information logged in the log database 206 between the times of receiving a previous data collection command and receiving the most recent data collection command.

The time period specifier 212 may be configured to employ one or more of a plurality of suitable techniques to obtain data logging time periods. For example, if the data logging time period is specified in the data collection command received from the administrator 210, the time period specifier 212 may obtain the data logging time period from the data collection command as described above. In another example implementation, the time period specifier 212 may include one or more registers (not shown) and a clock (not shown) indicating a present time value (e.g., a present date and a time of day) and synchronized with a clock associated with the event historian station 120 (FIG. 1). The time period specifier 212 may use a register to store the last date and time at which or the last data logging time period for which the OSF data file generator 202 obtained process control log information and stored the information in one of the plurality of OSF data files 208. In this manner, when the time period specifier 212 receives a data collection command from the administrator 210, the time period specifier 212 may determine a data logging time period based on the value stored in the register and the clock. For example, the time period specifier 212 may specify a data logging time period of one month if the clock indicates a date and time of January 1, 12:00 am, and a value stored in the register indicates that the last data collection command was received on December 31, 9:00 pm.

In yet another implementation, the time period specifier 212 may be communicatively coupled to a user interface via which a user can specify data logging time periods. In this case, a user can provide or specify timestamps indicating a particular range of time for which the time period specifier 212 should collect process control log information from the log database 206. The user may enter the timestamps via a text field or may select the timestamps from a plurality of available timestamps provided by the time period specifier 212 based on times for which process control log information is stored in the log database 206.

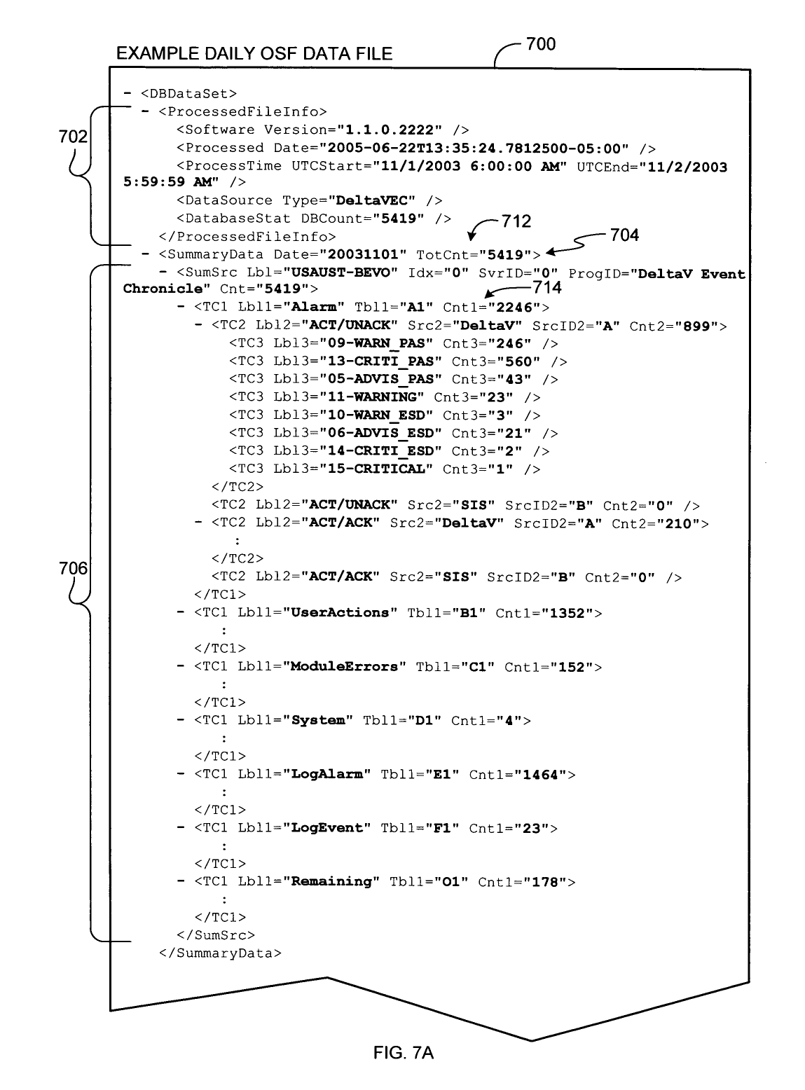

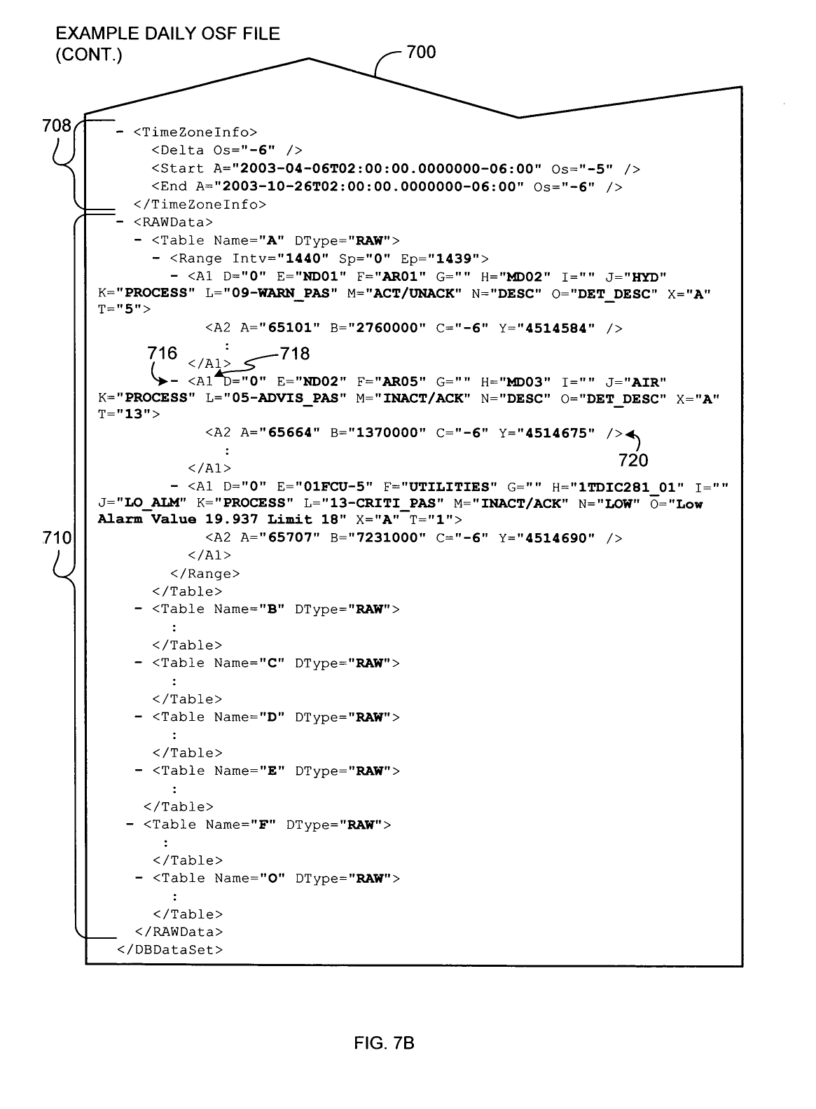

The OSF data file generator 202 includes a data queries interface 214 communicatively coupled to the time period specifier 212 and to the log database 206. The data queries interface 214 is configured to communicate data queries to the log database 206 to retrieve process control log information. In the illustrated example, the data queries interface 214 obtains data logging time period values and/or time offset values from the time period specifier 212. The data queries interface 214 can then communicate the data logging time period value or the time offset value via a data query to the log database 206 to retrieve the process control log information logged during the specified data logging time period or after the specified time offset. In the illustrated example, the process control log information retrieved by the data queries interface 214 from the log database 206 is in the form of raw data including detailed information associated with each logged instance or condition (of an event, alarm, action, etc.). For example, the log entries in the log database 206 may include tags (e.g., tags shown if FIGS. 5 and 6) or mnemonics associated with timestamps, source names, area names, unit names, or any other descriptive information (e.g., any of the descriptions shown in FIGS. 5 and 6) associated with the logged instances or conditions.

The data queries interface 214 can generate each data query used to collect process control log information based on a base query string, a data logging time period, and/or a time offset. The base query string may be designed or specified once during, for example, a design time (e.g., the time at which system engineers or application programmers specify parameter values for the OSF data file generator 202), and used by the data queries interface 214 a plurality of times to generate data queries. The base query string may include values or parameters associated with the types of process control information that a system engineer is most likely to request via, for example, the OSF data file interface 204. Alternatively, the data queries interface 214 may generate queries to retrieve all of the process control log information logged in the log database 206 during specified data logging time periods or after specified time offsets.

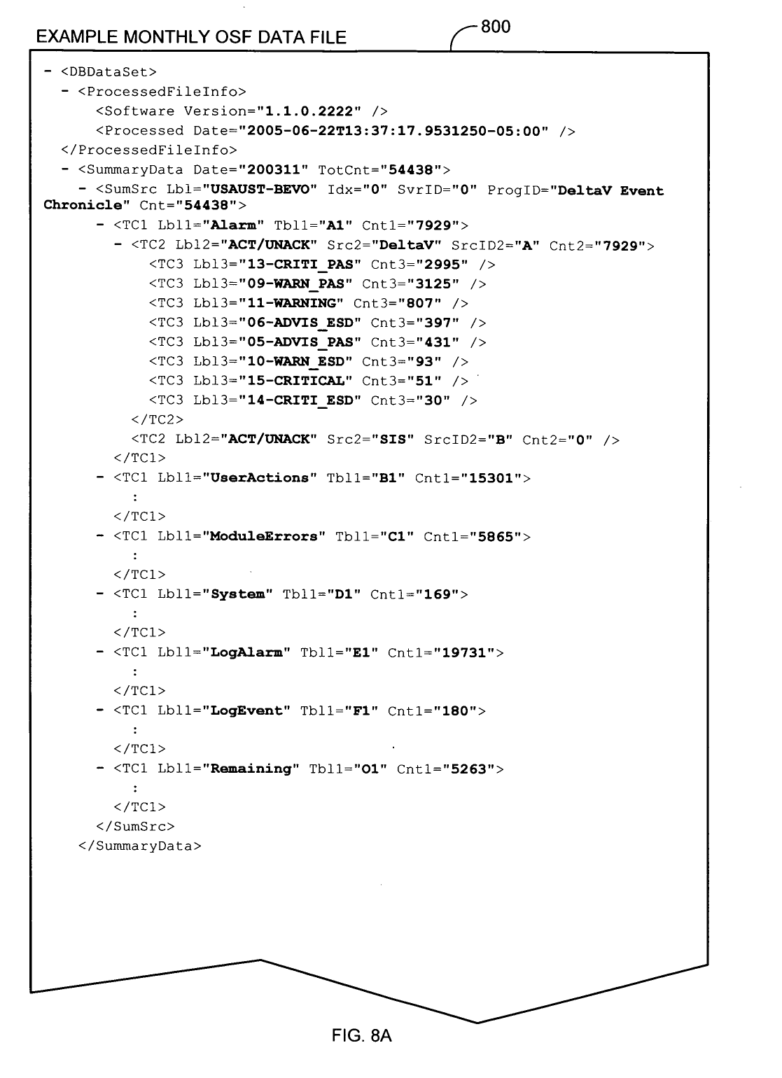

The OSF data file generator 202 includes a data processor 216 communicatively coupled to the data queries interface 214 and configured to categorize process control information into a plurality of data type categories. For example, the data queries interface 214 communicates the retrieved process control information to the data processor 216, and the data processor 216 categorizes the process control information into a plurality of pre-defined data type categories. The data type categories may include, for example, alarms, user actions, system events, module errors, log alarms, log events, etc. The data processor 216 groups the categorized process control log information into data type category segments 218. The data processor 216 may also be configured to generate summary information associated with the retrieved process control log information and store the summary information in the data type category segments 218. For example, the data processor 216 may determine total counts (e.g., a TotCnt parameter 712 and/or a Cnt1 parameter 714 of FIG. 7) associated with a number of log entries for each data type.

The data processor 216 may also be configured to filter the process control log information received from the data queries interface 214. For example, if the data queries interface 214 generates queries to retrieve all of the process control log information logged in the log database 206 during specified data logging time periods or after specified time offsets, the data processor 216 may filter the process control log information based on predefined data filters. In this case, the data filters may be defined at design time and may include values or parameters associated with the types of process control log information that a system engineer or user is most likely to request.

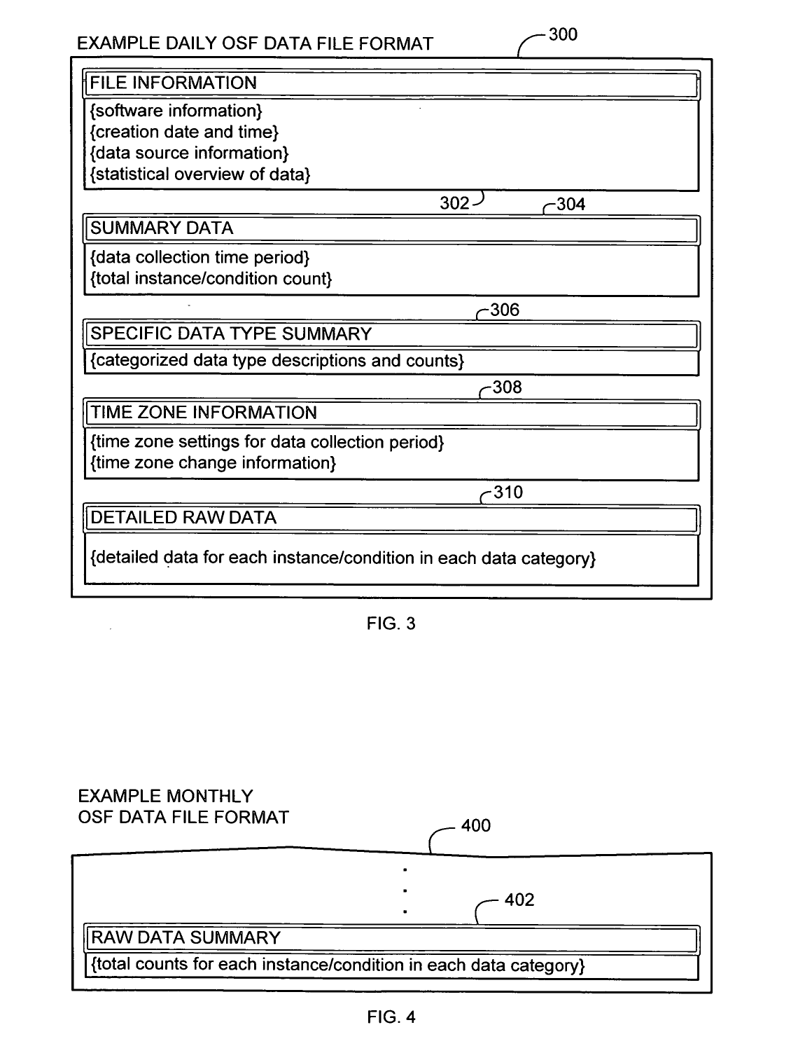

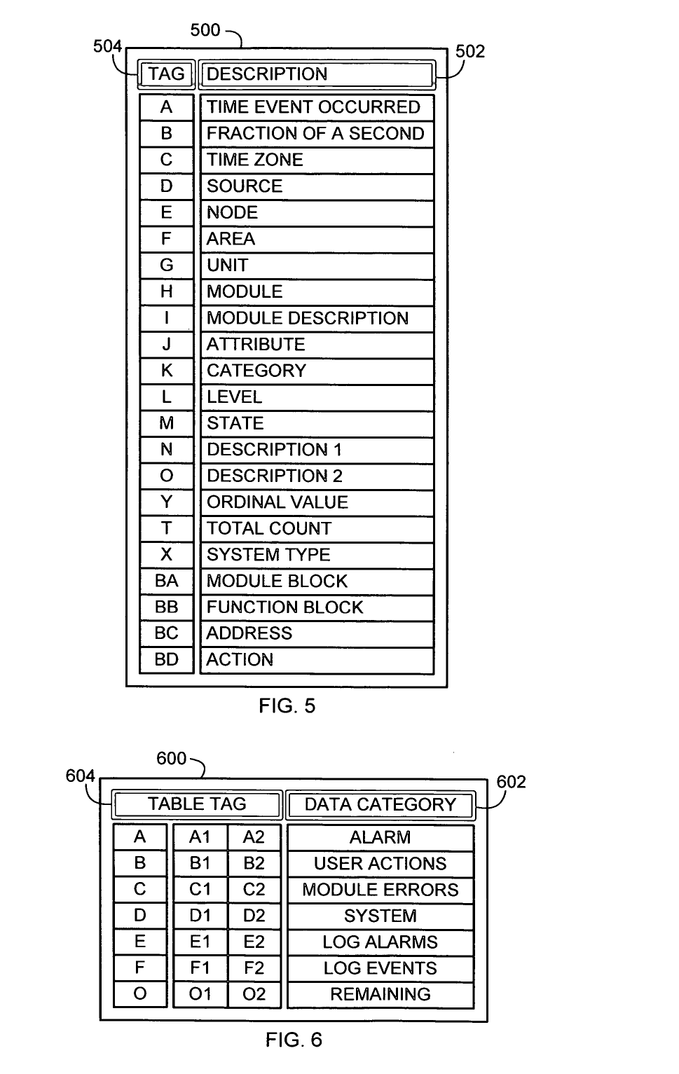

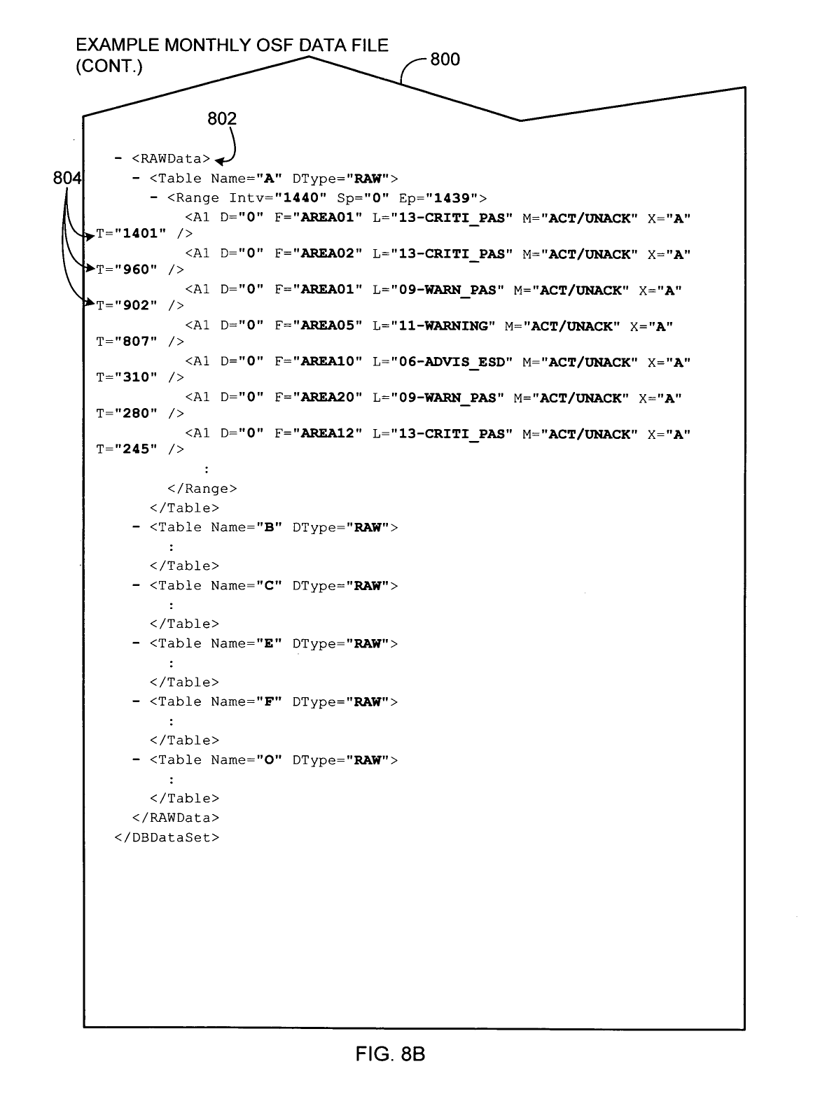

The OSF data file generator 202 includes an OSF data file formatter 220 communicatively coupled to the time period specifier 212 and the data processor 216, and is configured to generate the OSF data files 208 according to a particular data format or data organization and write process control information to the OSF data files 208. In the illustrated example, the OSF data file formatter 220 may be configured to format the OSF data files 208 based on example OSF data file formats described below in connection with FIGS. 3 and 4. In this manner, the OSF data file formatter 220 can generate daily and monthly OSF data files that are substantially similar or identical to the example OSF data files illustrated in FIGS. 7A, 7B, 8A, and 8B. The OSF data file formatter 220 may be communicatively coupled to a memory 222 in which the OSF data file formatter 220 stores the OSF data files 208. The memory may be implemented using any volatile or non-volatile memory and may be implemented in the same processor system or hardware system used to implement the OSF data file generator 202 and/or the OSF data file interface 204. Alternatively, the memory 222 may be implemented on a different system that is communicatively coupled via, for example, a network, to one or more systems used to implement the OSF data file generator 202 and/or the OSF data file interface 204.

The OSF data file formatter 220 is configured to obtain data logging time period values from the time period specifier 212 each time the time period specifier 212 obtains a data collection command from, for example, the administrator 210. The OSF data file formatter 220 uses the data logging time period values to determine they type of OSF data file to generate and/or to which OSF data to write the categorized process control log information. For example, if the data logging time period is a 24-hour time period, the OSF data file formatter 220 generates a daily OSF data file and writes the process control log information from the category type segments 218 to that daily OSF data file. If the data logging time period is one month, then the OSF data file formatter 220 generates a monthly OSF data file. The OSF data file formatter 220 also writes summary information from each of the category type segments 218 to the OSF data files.

If a daily OSF data file or a monthly OSF data file already exists for a particular data logging time period (due to a previous data collection specifying the same daily or monthly data logging time period), then the OSF data file formatter 220 writes the process control log information from the category data type segments 218 to the existing OSF data file. In this case, new summary information (e.g., new total counts for recently retrieved process control log information) in the category type segments 218 can be added to the summary information (e.g., existing total counts for previously retrieved process control log information) previously stored in the existing OSF data file.

For any particular process control information, the OSF data file generator 202 need only access the log database 206 one time to retrieve that particular process control log information and write the process control information to the OSF data files 208, thus, enabling a user to retrieve the process control log information from the OSF data files 208 any number of times thereafter. For instance, after the OSF data file generator 202 stores the process control log information in the OSF data files 208, a user may at any time thereafter use the OSF data file interface 204 to retrieve the process control log information from the OSF data files 208 without having to access the log database 206. In this manner, the OSF data file generator 202, the OSF data file interface 204, and the OSF data files 208 enable relatively faster access times associated with retrieving process control log information because the access times associated with retrieving process control log information from the OSF data files 208 are relatively less than the access times associated with retrieving process control log information from the log database 206.

A user may use the OSF data file interface 204 to retrieve process control log information from the OSF data files 208 by submitting a user request 224 to the OSF data file interface 204. In the illustrated example, the user request 224 may indicate daily or monthly data logging time periods and the date (e.g., month/day/year or month/year) associated with the data logging time period. The user request 224 may also indicate the type of process control log information that a user has requested. For example, a user may request a summary overview of the process control log information for a particular data logging time period or may request detailed process control log information associated with, for example, one or more particular instances or conditions (of an alarm, event, action, etc.). Additionally or alternatively, the user request 224 may indicate requested process control log information based on various data descriptions (e.g., the data descriptions shown in FIG. 5) and/or data type categories (e.g., the data type categories shown in FIG. 6).

The OSF data file interface 204 includes a time period identifier 226 and a requested information identifier 228, both configured to receive the user request 224. The time period identifier 226 is configured to determine a data logging time period based on the user request 224. The requested information identifier 228 is configured to identify the particular type of process control log information that is requested by a user based on the user request 224.

The OSF data file interface 204 includes a file reader 230 communicatively coupled to the time period identifier 226 and configured to retrieve process control log information from the OSF data files 208 based on the identified data logging time period. For example, if the data logging time period is a daily time period, then the file reader 230 accesses a daily OSF data file associated with a specific date obtained from the user request 224 by the time period identifier 226. The file reader 230 may be configured to retrieve some (e.g., one line of process control log information) or all of the process control log information from one of the OSF data files 208 during one read operation. If the file reader 230 is configured to read one line of process control log information from one of the OSF data files 208 during a read operation, then the file reader 230 may read all of the process control log information from the OSF data file in an iterative manner using a plurality of read operations based on other operations (e.g., filtering operations, analyzing operations, etc.) performed by other portions of the OSF data file interface 204.

The OSF data file interface 204 includes a data filter 232 communicatively coupled to the requested information identifier 228 and the file reader 230, and configured to filter the process control log information based on the user request 224. More specifically, after the file reader 230 reads the process control log information from one of the OSF data files 208, the file reader 230 communicates the process control log information to the data filter 232. The data filter 230 is configured to receive from the requested information identifier 228 one or more values, parameters, or messages indicating the type of process control log information indicated in the user request 224. The data filter 232 can then extract some, none, or all of the process control log information received from the file reader 230 based on the type of information indicated in the user request 224. For example, if the user request 224 indicates a request for summary information, then the data filter 232 can extract a summary information portion from the process control log information. On the other hand, if the user request 224 indicates a request for all of the process control log information collected for a specified date and stored in a particular one of the OSF data files 208, then the data filter 232 can retain all of the process control log information received from the filer reader 230.

In the illustrated example, the data filter 232 may be configured to filter the process control log information based on data type categories (e.g., alarms, user actions, module errors, systems, log alarms, log events, etc.), some of which are shown in FIG. 6. The data filter 232 may also be configured to filter the process control log information based on other data descriptions such as, for example, the descriptions shown in FIG. 5. Further, the data filter 232 may be configured to filter the process control log information based on time ranges such as, for example, a specified time range (e.g., 12:00 pm to 3:00 pm) within a data logging time period. A time range may be specified by a user via the user request 224. In any case, the data filter 232 may be configured to use any type of suitable data filter based on the requested process control information indicated in the user request 224.

The OSF data file interface 204 includes a data analyzer 234 communicatively coupled to the data filter 232 and configured to analyze the filtered process control log information obtained from the data filter 232. Specifically, the data analyzer 234 may be configured to generate count values, statistical values, interval time values between occurrences of particular instances or conditions, or generate any other type of analytical value associated with the particular process control log information filtered by the data filter 232. For example, if the user request 224 indicates requested process control log information logged within a particular time range, the data analyzer 234 may determine the count values associated with the occurrences of each type of instance or condition associated with that time range. Also, the data analyzer 234 may analyze the process control information to generate statistical values, such as, for example, percentage values or probability values. System engineers may use probability values to make decisions associated with day-to-day process control system operations, maintenance, upgrades, etc.

In an example implementation, the data analyzer 234 may be configured to generate pattern or relationship information associated with patterns or relationships between instances of alarms, events, actions, or any other types of log entries. For example, the data analyzer 234 may be configured to analyze a plurality of log entries read by the file reader 230 from one or more of the OSF data files 208 and find instances or occurrences of a particular type of alarm. For each instance of the particular type of alarm, the data analyzer 234 may analyze other instances of alarms, events, actions, etc. that occurred and were logged within a particular time period relative to that instance of the particular type of alarm. For example, for each instance of the particular alarm, the data analyzer 234 may analyze log entries that were logged within thirty seconds prior to and thirty seconds after that instance of the particular alarm was logged. In this manner, the data analyzer 234 may determine any similarities or patterns between log entries logged within a particular time period relative to each instance of the particular type of alarm and generate pattern or relationship information indicating whether two or more types of log entries may be related.

Example pattern or relationship information may indicate that a pressure alarm associated with a particular holding tank is asserted every time that a particular valve opens (e.g., a particular event occurs). System engineers may use pattern or relationship information to determine whether particular events or actions may be causes of alarms triggering in process control systems and to determine maintenance actions. The particular types of log entries to be analyzed to generate pattern or relationship information may be determined by the requested information identifier 228 based on the user request 224. Additionally or alternatively, the data analyzer 234 may be configured to determine pattern or relationship information in response to determining that a plurality of log entries associated with a particular type of log entry exceeds a threshold (e.g., an instance or occurrence threshold), which may be determined at a design time or provided via the user request 224.

The OSF data file interface 204 includes a pre-processor 236 communicatively coupled to the data analyzer 234 and the file reader 230. The pre-processor 236 is configured to obtain filtered process control log information and analysis values from the data analyzer 234 and organize the filtered process control log information based on, for example, data category, summary information, detailed information, analysis information, etc. to generate a plurality of pre-processed information segments 238. Each pre-processed information segment 238 may include process control information and analysis information associated with, for example, a particular data category, a particular time range, etc. The pre-processor 236 may also be configured to generate instance/condition count values or other statistical values in addition to the count values and statistical values generated by the data analyzer 234. In some cases, the pre-processor 236 may obtain count values (e.g., a TotCnt parameter 712 or a Cnt1 parameter 714 of FIG. 7) from the file reader 230.

In some example implementations, the pre-processor 236 may be configured to generate statistical information based on a portion (e.g., one line) of the process control log information. If the file reader 230 is configured to read the process control log information from one of the OSF data files 208 using a plurality of read operations, in which each read operation retrieves one of a plurality of portions (e.g., one of a plurality of lines) of the process control log information at a time, the pre-processor 236 may be configured to communicate a feedback signal or message to the file reader 230 when the pre-processor 236 is finished processing a previously retrieved portion. In this manner, the file reader 230 may retrieve another portion (e.g., another line) of the process control log information from the OSF data file based on another read operation.

To save storage space, the process control log information stored in the OSF data files 208 is tagged using pre-defined tags (e.g., the tags shown in FIGS. 5 and 6), some of which are single character tags. The process control log information in the pre-processed information segments 238 is identified using the pre-defined tags. However, to facilitate interpreting the process control log information by a user, a key or a legend is needed or the process control log information needs to be identified using meaningful labels or descriptions prior to outputting the process control log information to a user.

To label the process control log information with text, identifiers, or descriptions that can be interpreted by a user, the OSF data file interface 204 includes a post-processor 240 communicatively coupled to the pre-processor 236 and the time period identifier 226. The post-processor 240 is configured to obtain the pre-processed information segments 238 from the pre-processor 236 and produce processed information 242 by organizing the process control information in the pre-processed information segments 238 into a format and/or organization that facilitates interpreting and analyzing the process control information. The post-processor 240 may be provided with tables (e.g., the tables of FIGS. 5 and 6) that assign text identifiers, text descriptions, text strings, etc. to tags associated with the process control log information. The post-processor 240 is configured to replace each tag in the process control log information with a respective text description based on, for example, the tables of FIGS. 5 and 6.

The post-processor 240 may also be configured to process (e.g., generate statistical information, perform analyses, generate pattern and/or relationship information, etc.) and organize the process control log information. For example, in implementations in which the pre-processor 236 is configured to process a portion (e.g., a line) of process control log information at a time, the post-processor 240 may be configured to process a plurality of portions or all of the process control log information from one of the OSF data files 208 at a time. The post-processor 240 may then organize the process control log information into tables, columns, rows, or any other type of organization to generate the processed information 242, label the processed information 242 with an associated data logging time period obtained from the time period identifier 226, and output the processed information 242 to a client application, a web-based application, a storage medium, or to any other user-specified destination.

In an example implementation, the post-processor 240 may be configured to provide alarm configuration or alarm setting recommendations based on, for example, statistical information, pattern or relationship information, or any other analysis information. For example, for a particular type of alarm the post-processor 240 may analyze the process control log information obtained from the pre-processed information segments 238 to determine percent occurrence information and operating condition information associated with the instances or occurrences of that type of alarm. For example, the post-processor 240 may determine that relatively more log entries associated with a pressure alarm are associated with a pressure level (e.g., an operating condition) below a particular level. The post-processor 240 may then generate recommendation information indicating that setting the trigger level for that alarm above that particular level can reduce occurrences or instances of that alarm by, for example, a particular percentage.

Although the OSF data file generator 202 is described above as being configured to generate daily and monthly OSF data files, the OSF data file generator 202 may be configured to generate OSF data files associated with any other time period (e.g., one or more hours, one or more days, one or more weeks, one or more months, etc.). Additionally or alternatively, the OSF data file generator 202 may be configured to generate OSF data files associated with one type of data logging time period or a data logging time period of one duration (e.g., a 24-hour time period) and the OSF data file interface 204 may be configured to generate OSF data files associated with other types of data logging time periods (e.g., a week time period, a month time period, an hour time period, etc.). In this case, each of the OSF data files 208 is generated based on the same duration of time (e.g., each of the OSF data files 208 is a daily OSF data file). To generate OSF data files of different data logging time periods based on the OSF data files 208, the user request 224 may specify the other data logging time periods or the administrator 210 may be communicatively coupled to the OSF data file interface 204 an configured to communicate requests to the OSF data file interface 204 specifying the other data logging time periods. In any case, the process information 242 may be one or more OSF data files associated with data logging time periods that are different than the data logging time periods associated with the OSF data files 208.

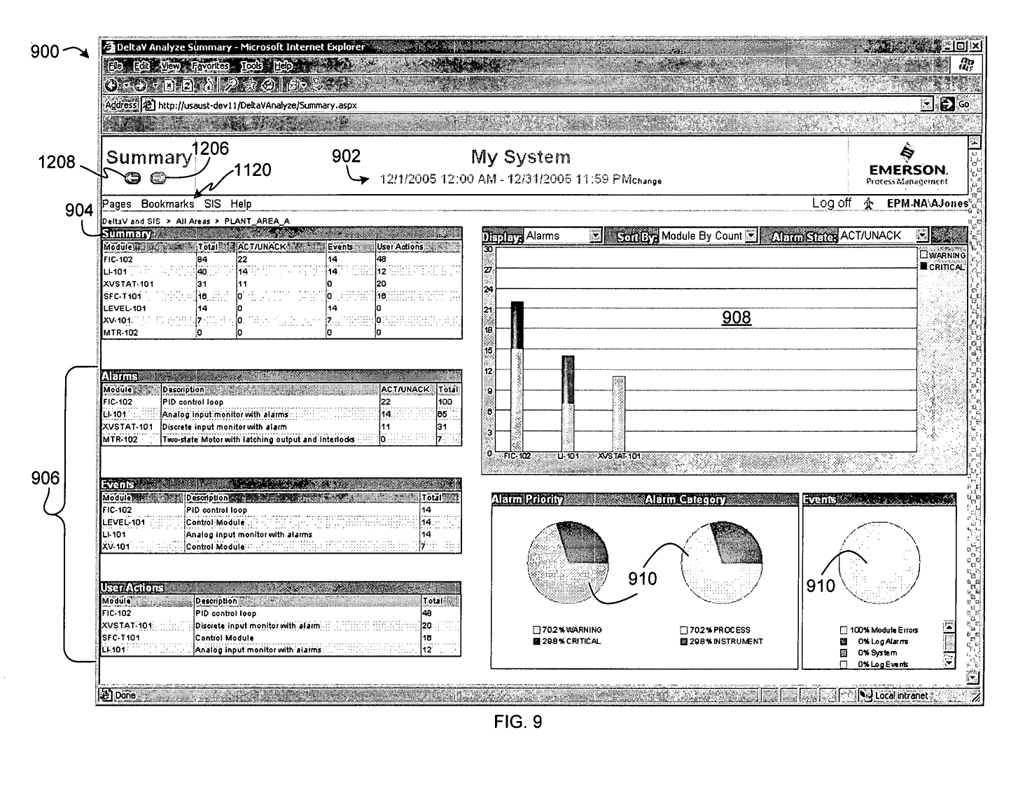

In an example implementation, the OSF data file generator 202 may be configured to generate comparison information associated with process control log information logged during different time periods. For example, the OSF data file generator 202 may be configured to generate a historical summary associated with a particular data logging time period based on one or more of the OSF data files 208 and compare the historical summary to process control log information logged during a shorter or different data logging time period. In this manner, the OSF data file generator 202 may generate difference information based on the comparison indicating, for example, percentages of more or less occurrences of particular types of log entries, and provide the difference information in the processed information 242. The OSF data file generator 202 may also provide in the processed information 242 different or separate summary information (or detailed information) for different data logging time periods (e.g., first summary information associated with a first data logging time period and second summary information associated with a second data logging time period). In this manner, a user may view the different summary information (or detailed information) in a side-by-side display configuration via a user interface (e.g., an example web-based user interface 900 of FIG. 9).

FIGS. 3 and 4 depict example OSF data file formats that may be used to generate the OSF data files 208 (FIG. 2) and to organize process control log information and other information therein. However, the formats used to generate and organize data in the OSF data files 208 are not limited to those described below in connection with FIGS. 3 and 4. Instead, any other suitable format may alternatively or additionally be used to generate the OSF data files 208. Example OSF data files shown in FIGS. 7A, 7B, 8A, and 8B are organized based on the example OSF data file formats of FIGS. 3 and 4.

FIG. 3 depicts an example daily OSF data file format 300. The example daily OSF data file format 300 depicts an example format that the OSF data file formatter 220 of FIG. 2 may use to generate and format the ones of the OSF data files 208 (FIG. 2) that are associated with a daily data logging time period and to store process control log information therein. The example daily OSF data file format 300 includes a plurality of information sections including a file information section 302, a summary data section 304, a specific data type summary section 306, a time zone information section 308, and a detailed raw data section 310. The file information section 302 includes information associated with a particular daily OSF data file. In the illustrated example, the file information section 302 includes software name and version information, date and time of creation or modification of the daily OSF data file, data source information (e.g., a name or identification of the log database 206 of FIG. 2), and statistical overview values associated with the process control information stored in the particular daily OSF data file. Of course, the file information section 302 may include any other type of information associated with the daily OSF data file, the information stored in the daily OSF data file, accesses performed on the daily OSF data files, security information, etc.

The summary data section 304 includes summary information associated with the process control log information stored in a particular daily OSF data file. In the illustrated example, the summary data section 304 includes a data collection time period and a total instance count and/or condition count. The data collection time period indicates the data logging time period during which the process control log information was acquired and logged by the log database 206. The total instance and/or condition count indicates the number of instances and/or conditions associated with alarms, events, actions, etc. that occurred during the data logging time period and for which process control information is stored in the daily OSF data file. The specific data type summary section 306 includes categorized data type descriptions and counts associated with each data type for which process control information is stored in a daily OSF data file.

The time zone information section 308 includes a time zone setting (e.g., based on Greenwich Mean Time (GMT)) associated with the data logging time period during which the log database 206 acquired and logged the process control information that is stored in a particular daily OSF data file. The detailed raw data section 310 includes detailed data for each instance or condition associated with each data category. The OSF data file formatter 220 uses the detailed raw data section 310 to store the raw data log entries obtained by the data queries interface 214 from the log database 206.

FIG. 4 depicts a portion of an example monthly OSF data file format 400. The OSF data file formatter 220 of FIG. 2 may use the example monthly OSF data file format 400 to generate and format the ones of the OSF data files 208 (FIG. 2) that are associated with monthly data logging time periods. Although not shown, the example monthly OSF data file format 400 may include a file information section, a summary data section, a specific data type summary section, and a time zone information section that are substantially similar or identical to the file information section 302, the summary data section 304, the specific data type summary section 306, and the time zone information section 308, respectively, of the example daily OSF data file format 300 (FIG. 3). However, instead of the detailed raw data section 310 of the daily OSF data file format 300, the monthly OSF data file format 400 includes a raw data summary section 402. In the illustrated example, the raw data summary section 402 includes a plurality of total count values. Each total count value is associated with the number of instances or conditions in each data category (e.g., instances or conditions associated with alarms, events, actions, errors, etc.) that occurred in a particular month.

FIG. 5 is a legend 500 having a plurality of data descriptions 502 associated with a plurality of tags 504, and FIG. 6 is another legend 600 having a plurality of data category descriptions 602 associated with a plurality of table tags 604. To optimize the memory storage requirements of the OSF data files 208 (FIG. 2), the number of characters required to label or identify the process control log information is minimized by using the tags 504 and 604 shown in the legends 500 and 600. To facilitate interpreting or analyzing the process control log information that is output to a user by the OSF data file interface 204, the legends 500 and 600 may be provided to the post-processor 240 (FIG. 2). The post-processor 240 may use the legends 500 and 600 to label, identify, or otherwise provide descriptive information in the processed information 242 (FIG. 2) describing the process control log information. The tags 504 and 604 shown in the legends 500 and 600 are depicted in example OSF data files shown in FIGS. 7A, 7B, 8A, and 8B to label or identify process control information.

As shown in FIG. 5, the legend 500 includes the tags 504 for various types of information that may be acquired and logged in the log database 206 for each instance or condition associated with an alarm, event, action, etc. As shown in FIG. 6, the legend 600 includes the table tags 604 associated with various types of data categories 602 that may be used to organize the process control information. Of course, in alternative implementations, the legends 500 and 600 may include more or less tags and descriptions or data categories.

FIGS. 7A and 7B depict an example daily OSF data file 700 and FIGS. 8A and 8B depict an example monthly OSF data file 800. The example OSF data files 700 and 800 are shown merely for purposes of example, and may be modified in one or more ways to suit particular process control systems. For purposes of clarity, some process control log information is not shown, while other process control log information, label information, data category information, etc. is shown to illustrate by way of example the types of process control log information and any other types of information that can be stored in the example OSF data files 700 and 800. The example OSF data files 700 and 800 may represent some of the OSF data files 208 generated and written to by the OSF data file generator 202 described above in connection with FIG. 2.

The example daily OSF data file 700 of FIGS. 7A and 7B includes a file information section 702 generated based on the file information section 302 (FIG. 3), a summary data section 704 generated based on the summary data section 304 (FIG. 3), a specific data type summary section 706 generated based on the specific data type summary section 306 (FIG. 3), a time zone information section 708 generated based on the time zone information section 308 (FIG. 3), and a detailed raw data section 710 generated based on the detailed raw data section 310 (FIG. 3).

As shown in the summary data section 704, a TotCnt parameter 712 indicates that 5,419 is the total number of instances/conditions logged for the particular type of data represented in the example daily OSF data file 700 during the particular data logging time period associated with the example daily OSF data file 700. The specific data type summary section 706 includes total counts for various instances or conditions organized by data type category (e.g., an alarm category, a user actions category, a module errors category, a system category, a log alarm category, a log event category, and a remaining category). A Cnt1 parameter 714 in the specific data type summary section 706 indicates that 2,246 instances/conditions were logged under the alarm data type category. Count values associated with count parameters (e.g., the TotCnt parameter 712 and the Cnt1 parameter 712) may be generated by the data processor 216 (FIG. 2) based on the process control log information stored as raw data in the detailed raw data section 710.

In the specific data type summary section 706 the instances/conditions associated with each data type category can be further categorized based on other criteria. In the illustrated example, the instances/conditions associated with the alarm data type category are further categorized based on action/unacknowledged (“ACT/UNACK”) and action/acknowledge (“ACT/ACK”) criteria. Of course, the instances/conditions can be further categorized based on any other types of criteria as well.

The detailed raw data section 710 includes a plurality of raw data entries associated with each of the data categories summarized in the specific data type summary section 706. The raw data entries stored in the detailed raw data section 710 are retrieved by the data queries interface 214 from the log database 206 as described above in connection with FIG. 2. As shown in the detailed raw data section 710, a raw data entry 716 includes a category type identifier 718. The category type identifier 718 is associated with the table tags 604 of the legend 600 (FIG. 6). For example, a category type identifier ‘A1’ indicates the alarm data type category. The raw data entry 716 includes a timestamp entry 720 indicating when an instance or condition associated with the raw data entry 716 occurred in a process control system (e.g., the process control system 110 of FIG. 1). Although one timestamp entry is shown, a plurality of timestamp entries may be provided for the raw data entry 716, each representing a time of day that an instance or condition associated with the raw data entry 716 occurred.

The raw data entry 716 and the timestamp entry 720 include a plurality of description information parameters (e.g., ‘D’, ‘E’, ‘F’, etc.), each of which is associated with one of the tags 504 of the legend 500 (FIG. 5). The post-processor 240 of FIG. 2 can use the description information parameters and category type identifiers (e.g., the category type identifier 718) in combination with the legends 500 and 600 to organize and label user requested process control log information, thus, facilitating interpretation and analysis of the process control log information by a user.

The example monthly OSF data file 800 of FIGS. 8A and 8B includes total monthly count values in various sections that represent instances and/or conditions associated with particular data types that occurred in a one-month data logging time period. Unlike the detailed raw data section 710 of the example daily OSF data file 700, a raw data summary section 802 of the example monthly OSF data file 800 includes total monthly count values 804 associated with the number of instances and/or conditions represented in the detailed raw data section 710 by raw data entries and timestamp entries (e.g., the raw data entry 716 and the timestamp entry 720). In this manner, a user may request an overview of the instance/condition total monthly counts for a particular month and obtain the total monthly count information from a monthly OSF data file (e.g., the monthly OSF data file 800). After analyzing the total monthly count information, the user may select to retrieve detailed process control log information for a particular day and a particular data type category, in which case the OSF data file interface 204 (FIG. 2) may retrieve the detailed process control log information from a daily OSF data file (e.g., the example daily OSF data file 700).

FIG. 9 is an example web-based user interface 900 that may be used to access process control log information from the example OSF data files of FIGS. 7A, 7B, 8A, and 8B. The example web-based user interface 900 may be used by a user to interact or interface with the OSF data file interface 204 (FIG. 2) to retrieve process control log information from the OSF data files 208 (FIG. 2). The web-based user interface 900 may be associated with a web-based application (e.g., a server-side web application) that is installed and executed on the web server 122 of FIG. 1 to enable a user to submit user requests (e.g., the user request 224 of FIG. 2) to the OSF data file interface 204 via any type of web browser (e.g., Internet Explorer®, Netscape Navigator®, Mozilla®, etc.). In the illustrated example, a user may submit user requests via the web-based user interface 900 by clicking on or selecting portions (e.g., drop down boxes, graphics, text, hyperlinks, etc.) of the web-based user interface 900. Other implementations of web-based user interfaces that may be used in combination with the example systems and methods described herein to communicate with the OSF data file interface 204 may include other graphical user interface features (e.g., text boxes, radio buttons, check boxes, etc.) that can be used to enter user requests.

The process control log information represented in the example web-based user interface 900 is associated with a monthly OSF data file as indicated by a date header 902. The web-based user interface 900 includes a summary section 904 showing total monthly count information for various areas of a process control system (e.g., the process control system 110 of FIG. 1). The web-based user interface 900 also includes a plurality of data type summary sections 906 showing total monthly count information for various data types. To compare various total monthly counts to one another, the web-based user interface 900 includes a column graph 908 and a plurality of pie charts 910. Of course, any other type of graph or chart may be used to present results, counts, or other analyses associated with the process control log information. In the illustrated example, the column graph 908 is used to display count or percentage values of various types of conditions (e.g., a warning condition, an advisory condition, a critical condition) associated with alarms or events in a side-by-side and stacked configuration. In this manner, the web-based user interface 900 facilitates comparisons of various process control log information. For example, the side-by-side and stacked configuration enables comparing process control log information statistics or counts with industry standard values (e.g., Engineering Equipment and Materials Users Association (“EEMUA”) alarm levels) and enables comparing performances of various process control systems or various areas of a process control system.

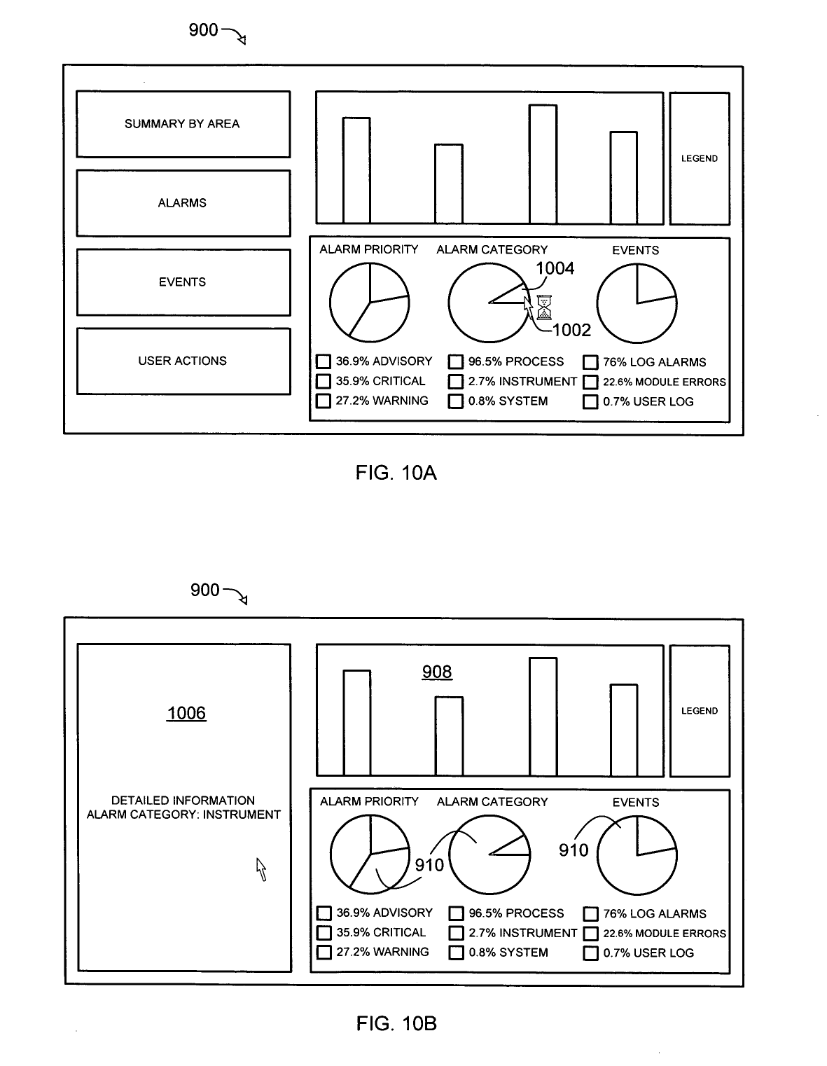

FIGS. 10A and 10B depict a portion of the example web-based user interface 900 of FIG. 9 used to display detailed information associated with a selected type of process control log information. The web-based user interface 900 as illustrated in FIGS. 10A and 10B depicts the manner in which a web-based application can change the display configuration of the web-based user interface 900 to display detailed information in response to a user request. Specifically, in the illustrated example of FIG. 10A, after analyzing summary information, a user may operate a mouse pointer 1002 to select a pie chart portion 1004 associated with instrument alarms. In response to the user selecting the pie chart portion 1004, the web-based application may submit a user request (e.g., the user request 224 of FIG. 2) to the OSF data file interface 204 to retrieve detailed process control log information associated with instrument alarms. After obtaining the instrument alarm process control log information, as shown in FIG. 10B, the web-based application may display detailed information about the instrument alarms in a detailed information area 1006 adjacent to the column graph 908 and the pie charts 910. In this manner, the web-based user interface 900 can display detailed information and summary information at the same time or via the same user interface screen so that a user may view and analyze the detailed and summary information substantially simultaneously and/or without having to navigate between two or more web pages.

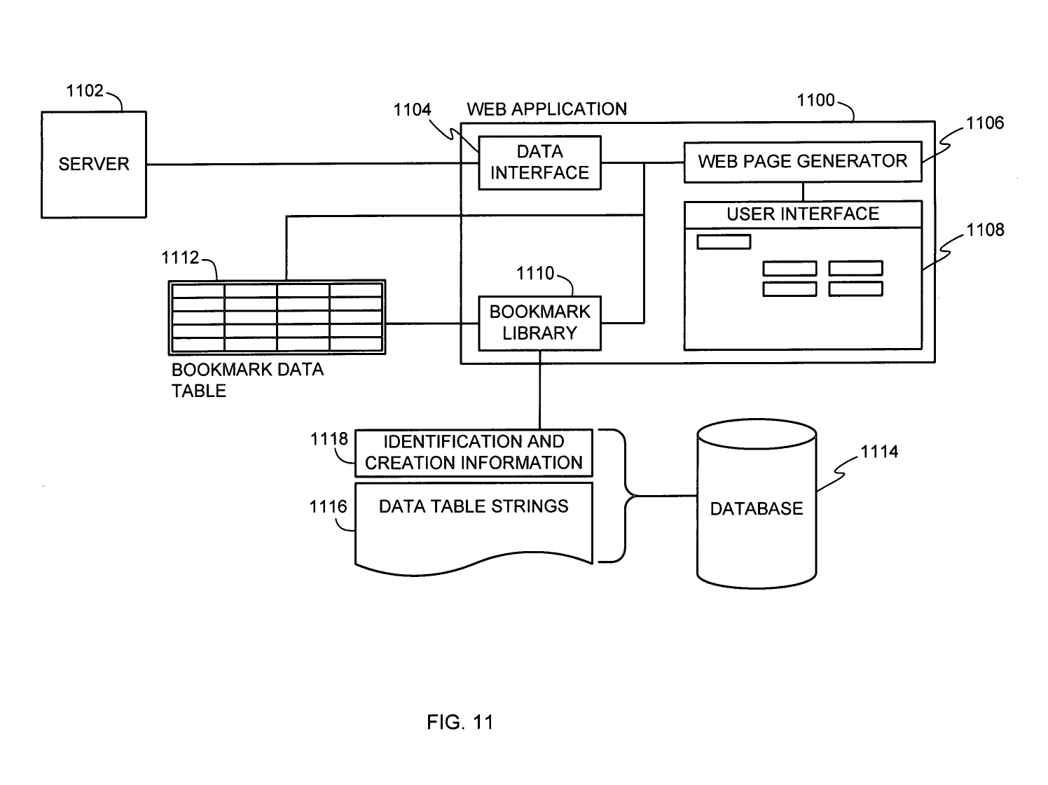

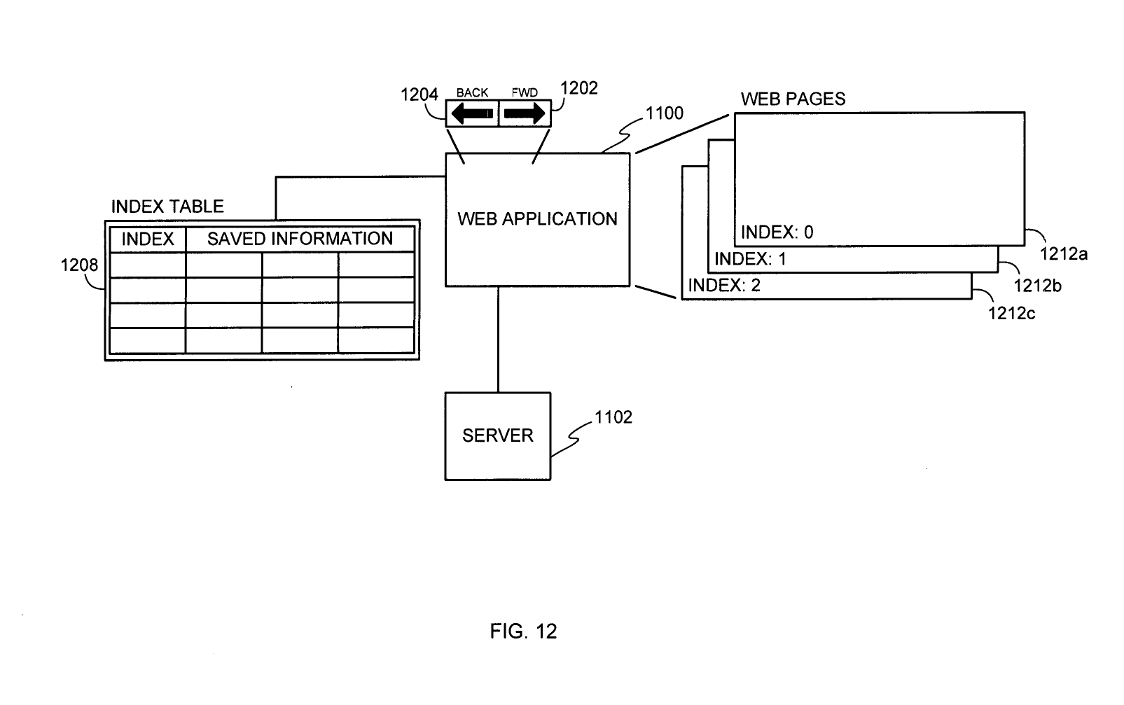

FIGS. 11 and 12 depict an example web application 1100 (e.g., a web-based application) configured to generate bookmarks associated with web pages having dynamic information (i.e., a dynamically generated web page or a dynamic web page) and to generate web page histories used to maintain or preserve changed data field values during backward and forward navigation of web pages as described in detail below. Although the web application 1100 is described below as being configured to generate bookmarks for dynamic web pages and to generate web histories, in an alternative implementation the web application 1100 may be configured to generate bookmarks and another web application may be configured to generate web histories. A user may use, interact with, or otherwise access the web application 1100 via any web browser application including, for example, Internet Explorer®, Netscape Navigator®, Mozilla®, etc. As shown in FIG. 11, the web application 1100 is communicatively coupled to a server 1102, which may be substantially similar or identical to the web server 122 of FIG. 1. The web application 1100 may be communicatively coupled to the server 1102 via any type of wireless or wired LAN or WAN (e.g., the LAN 124 of FIG. 1) or via the Internet.

Although FIGS. 11 and 12 depict the web application 1100 communicatively coupled to the server 1102, in some example implementations, the web application 1100 may be installed in the server 1102 and the server 1102 may perform the operations associated with implementing the web application 1100. In this case, the web application 1100 may be implemented using a server-side web application that users may access via any processor system that is communicatively coupled to the server 1102. For example, referring to FIG. 1, the web application 1100 may be installed and executed on the web server 122 and a user may access the web application 1100 via any of the other systems (e.g., the application station 102, the operator stations 104, the workstation 118, or the event historian station 120) shown in FIG. 1. In alternative implementations, the web application 1100 may be implemented using any type of thin client application technology or any other technology (e.g., active server pages, java servlets, hypertext preprocessor (“PHP”), etc.) that enables dynamically generating web pages and/or enables client-side information presented via a web browser (e.g., a client) and generated based on server-side information stored in a server or other corresponding data source to be substantially different from the server-side information.

FIG. 11 depicts the example web application 1100 configured to generate bookmarks associated with dynamic web pages. Specifically, the web application 1100 is configured to generate bookmarks (e.g., favorites links) that enable users to return to dynamic web pages to view the same information that was displayed via the web pages at the time the bookmarks were generated. A dynamic web page is generated by a creator web page based on information provided by, for example, a user or a data resource. For example, a creator web page may obtain the user-provided or the data resource-provided information and generate the dynamic web page by retrieving data (e.g., process control log information) based on that information. In some implementations, the creator web page and the dynamic web page may be the same web page or may be displayed via the same web page interface, in which case during a web browsing session the creator web page displays first information and the dynamic web page displays second information and some or none of the first information.

In an example implementation associated with the web-based user interface 900 of FIGS. 9, 10A, and 10B, the web-based user interface 900 as depicted in FIG. 10A may be a creator web page and the web-based user interface 900 as depicted in FIG. 10B may be a dynamic web page. The creator web page shown in FIG. 10A contains or displays first information, which includes the summary sections 904 and 906, the column graph 908, and the pie charts 91 0. The dynamic web page shown in FIG. 10B contains or displays second information, which includes the detailed information area 1006. In the illustrated example, the dynamic web page also displays some of the first information including the column graph 908 and the pie charts 910. The creator web page of FIG. 10A causes the web application 1100 to generate or create the dynamic web page of FIG. 10B by obtaining detailed instrument alarm information from the OSF data file interface 204 in response to obtaining user-provided information (e.g., selection of the pie chart portion 1004) and displaying the instrument alarm information in the detailed information area 1006 of the dynamic web page of FIG. 10B.

In general, the web application 1100 is configured to generate bookmarks by saving re-creation information (e.g., the user-provided or data-resource provided information) submitted via creator web pages. In this manner, any time that a user selects a particular bookmark associated with a dynamic web page, re-creation information can be submitted to the creator web page and the creator web page can dynamically generate the bookmarked dynamic web page to show the same information that was displayed at the time that the bookmark was generated.

To obtain web page information (e.g., process control log information) from the server 1102, the web application 1100 is provided with a data interface 1104. The data interface 1104 communicates the web page information to a web page generator 1106 that is configured to render web pages via a user interface 1108. To generate bookmarks that enable a user to return to dynamic web pages to view the same information that was displayed at the time the bookmarks were generated, the web application 1100 is provided with a bookmark library 1110. The bookmark library 1110 is communicatively coupled to the data interface 1104 and the web page generator 1106. The bookmark library 1110 is also communicatively coupled to a bookmark data table 1112 that is configured to temporarily store re-creation information. Additionally, the bookmark library 1110 is communicatively coupled to a database 1114 to store the bookmarks generated for the dynamically generated web pages.

After the web page generator 1106 obtains all re-creation information required to dynamically generate a web page, the web page generator 1106 in combination with a creator web page may dynamically generate the web page. If a user selects to generate a bookmark for the dynamic web page, the web page generator 1106 may store in the bookmark data table 1112 all of the re-creation information required to dynamically generate the displayed web page. For example, if the dynamic web page is the web-based user interface 900 as shown in FIG. 10B, the re-creation information that the web page generator 1106 would store in the bookmark data table 1112 may be, for example, a data logging time period, data type categories associated with the displayed process control log information, the selection of the pie chart portion 1004 shown in FIG. 10A that causes the detailed information area 1006 (FIG. 10B) to be displayed, and any other parameters or information required for the creator web page to retrieve the process control log information from the OSF data file interface 204 and re-create the bookmarked dynamic web page.

The bookmark library 1110 is configured to then generate a bookmark by converting the information stored in the bookmark data table 1112 into one or more data table strings 1116 and by generating identification and creation information 1118 associated with the data table strings 1116 to identify the bookmark being generated. The identification and creation information 1118 may include a name of the bookmark, the address (e.g., a uniform resource locator (URL) address) of the creator web page, and the date on which the bookmark was generated. The data table strings 1116 and the identification and creation information 1118 may be written and stored in XML format. In the illustrated example, the bookmark library 1110 stores the data table strings 1116 and the identification and creation information 1118 in the database 1114 for subsequent retrieval.

To facilitate user access to the bookmarks stored in the database 1114, the web page generator 1106 may display a listing of the stored bookmarks via a web page based on identification and creation information (e.g., the identification and creation information 1118). For example, the web page generator 1106 may display the stored bookmark listing in response to receiving user input associated with a user selecting, for example, a bookmark control 1120 shown in FIG. 9. After the web page generator 1106 displays the stored bookmark listing and a user selects a bookmark, the bookmark library 1110 may retrieve the one or more data table strings (e.g., the data table strings 1116) associated with the selected bookmark, retrieve the creator web page address of the selected bookmark, and communicate the creator web page address and the information in the data table strings to the web page generator 1106. The web page generator 1106 may then use the creator web page address and the information from the data table strings 1116 to cause the creator web page to dynamically re-generate the bookmarked web page.

FIG. 12 is the example web application 1100 of FIG. 11 configured to generate web page histories used to maintain (i.e., preserve) changed data field values during backward and forward navigation of web pages. Web pages such as, for example, configuration web pages associated with process control systems (e.g., the process control system 110 of FIG. 1) often include forms having text fields or other input fields for inputting configuration settings or selections. The example web application 1100 generates web page histories as described below to ensure that changed information provided by users to the web pages by, for example, entering or modifying information in the input fields, are maintained or preserved during forward and backward navigation of the web pages. In other words, the web application 1100 uses the web page histories to ensure that any change made to any input field on a web page can be re-displayed to a user if the user navigates away from that web page and subsequently returns to the web page using a forward control 1202 and/or a backward control 1204 of the web application 1100. The forward and backward controls 1202 and 1204 are substantially similar or identical to forward and backward controls 1206 and 1208, respectively, of the web-based user interface 900 of FIG. 9. In the illustrated example of FIG. 9, the forward and backward controls 1206 and 1208 are configured to communicate user-input, instructions, or commands to a web-based application (e.g., a server-side web application) that is installed and executed on, for example, the web server 122 of FIG. 1 indicating that the web-based application should provide a previously displayed web page or information (e.g., summary information associated with the summary sections 904 and 906 of FIG. 9 or detailed instrument alarm information associated with the detailed information area 1006 of FIG. 10) associated with a previously displayed web page.

The web application 1100 is communicatively coupled to an index table 1210 in which the web application 1100 may store web page histories associated with a plurality of web pages 1212a-c. The web application 1100 tracks or organizes the web page histories stored in the index table 1210 based on index values assigned to web pages as they are generated or loaded by the web application 1100. For example, when the web application 1100 is initially opened, the web application 1100 loads or displays the first web page and assigns the first web page an index value zero (‘0’). When a user provides or submits a request to the web application 1100 via, for example, a hyperlink, to navigate to a new web page the web application 1100 increments the index value of the previous web page (e.g., the initially loaded web page) by one (e.g., index value one (‘1’)) and assigns the index value zero to the most recently newly loaded web page. As the user requests to navigate to other new web pages, the web application 1100 increments the index values of the previously loaded web pages accordingly and assigns the index value zero to the most recently newly loaded web page.

As shown in FIG. 12, the web page 1212a is the most recently newly generated or loaded web page and is assigned the index value zero. The web page 1212b is the previously loaded web page and has an index value one. Before navigating from the web page 1212b to the web page 1212a, the web application 1100 increments the index value of the web page 1212b to index value one and stores in the index table 1210 any changed values made by a user to any input fields in the web page 1212b. Specifically, the web application 1100 stores the changed values in a saved information entry associated with the index value of the web page 1212b (e.g., index value one). Each time the web application 1100 loads or generates a new web page and increments the index values of the previously loaded web pages, the web application 1100 also increments the index values in the index table 1210. In this manner, the index values in the index table 1210 coincide with the index values of the plurality of web pages 1212a-c.

When a user uses the forward and/or backward controls 1202 and 1204 to navigate to a previously loaded one of the plurality of web pages 1212a-c, the web application 1100 determines if any changed values are stored in the index table 1210 for the previously loaded one of the plurality of web pages 1212a-c to which the user is navigating. After retrieving any saved values from the index table 1210, the web application 1100 retrieves any unsaved or unchanged values associated with the previously loaded web page from the server 1102. In this manner, the web application 1100 ensures that any values that were changed by the user prior to navigating away from the previously loaded web page are displayed to the user in addition to any unchanged values obtained from the server 1102 when the user navigates back to the previously loaded web page. The web application 1100 is configured to generate web page histories and load previously displayed web pages associated with any index value based on user-input associated with the forward and backward controls 1202 and 1204. In other words, if the web application 1100 displays a web page having an index value of one or greater in response to receiving user-input associated with the backward control 1204, subsequent user-input associated with the forward control 1202 causes the web application 1100 to display a previously loaded web page having an index value less than the currently loaded web page in a manner substantially similar or identical to that used in response to receiving user-input associated with the backward control 1204.

FIGS. 13 through 18 are flowcharts that depict example methods that may be used to implement the example methods and systems described herein. The example methods depicted in the flow diagrams of FIGS. 13 through 18 may be implemented in software, hardware, and/or any combination thereof. For example, the example methods may be implemented in software that is executed via the example processor system 1910 of FIG. 19 and/or a hardware system configured according to the example system 200 of FIG. 2. Although, the example methods are described below as a particular sequence of operations, one or more operations may be rearranged, added, and/or eliminated to achieve the same or similar results.

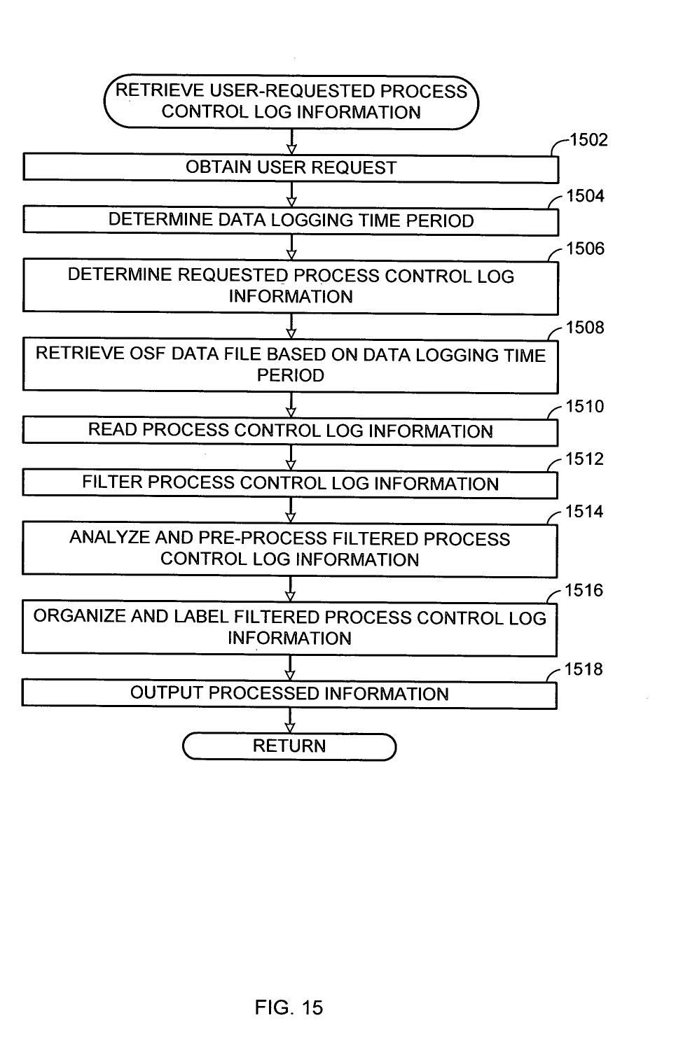

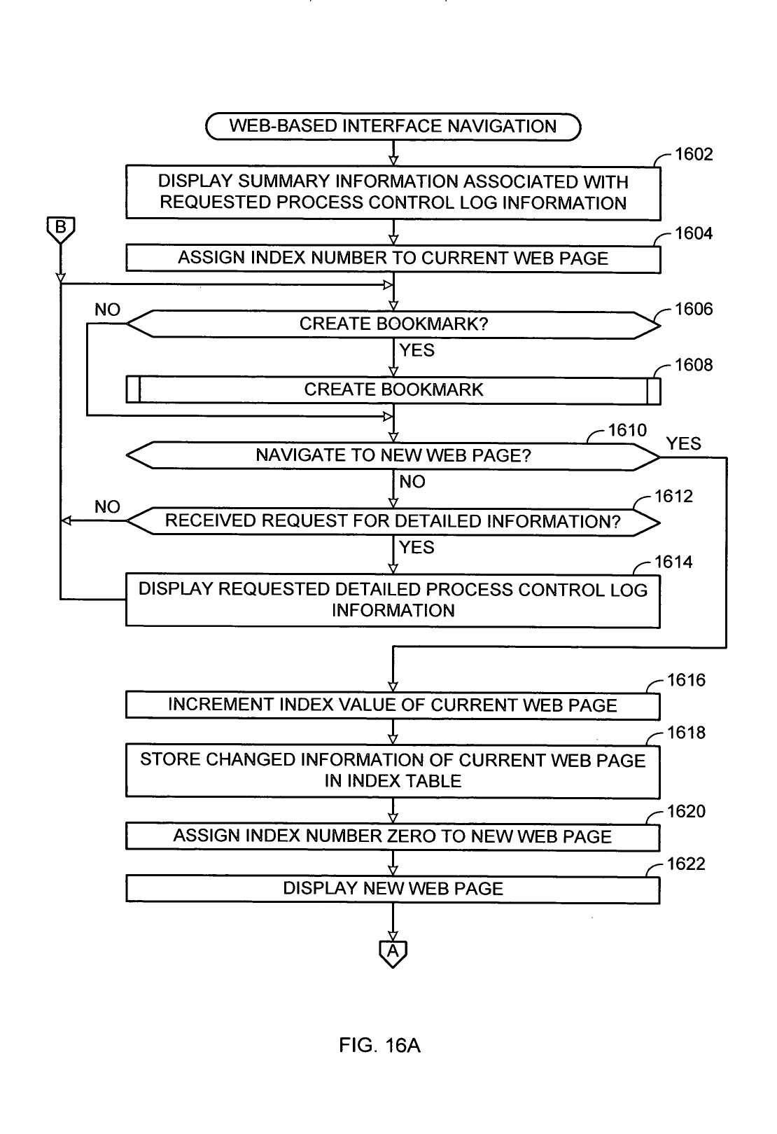

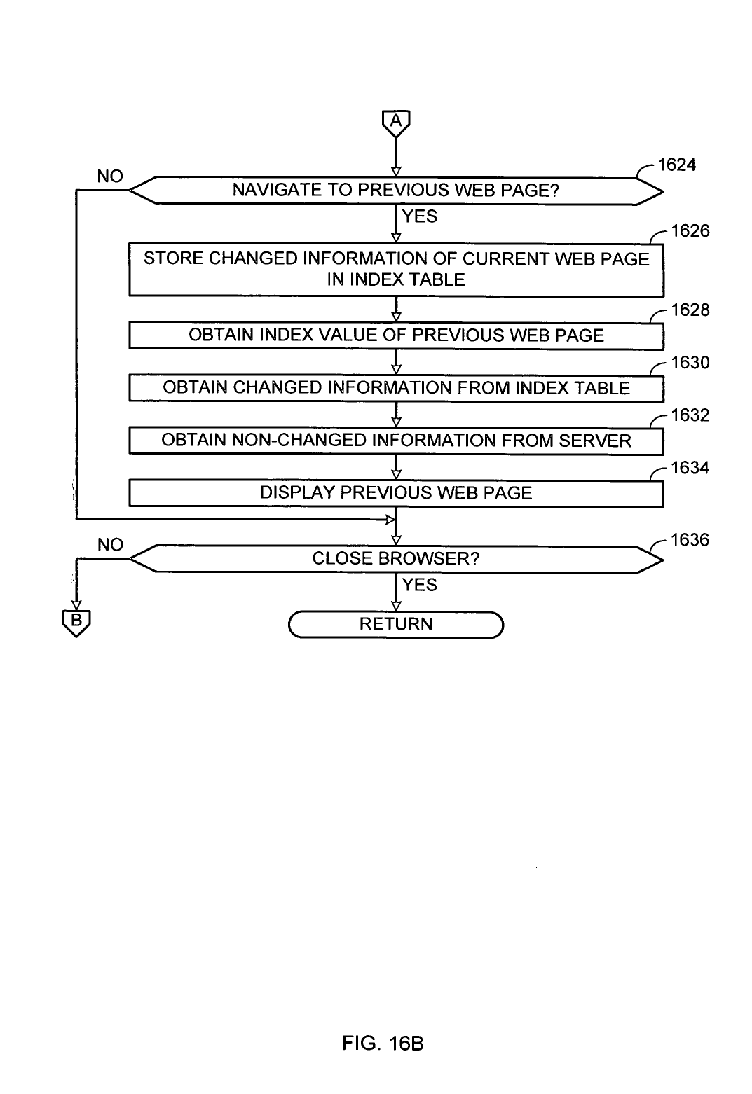

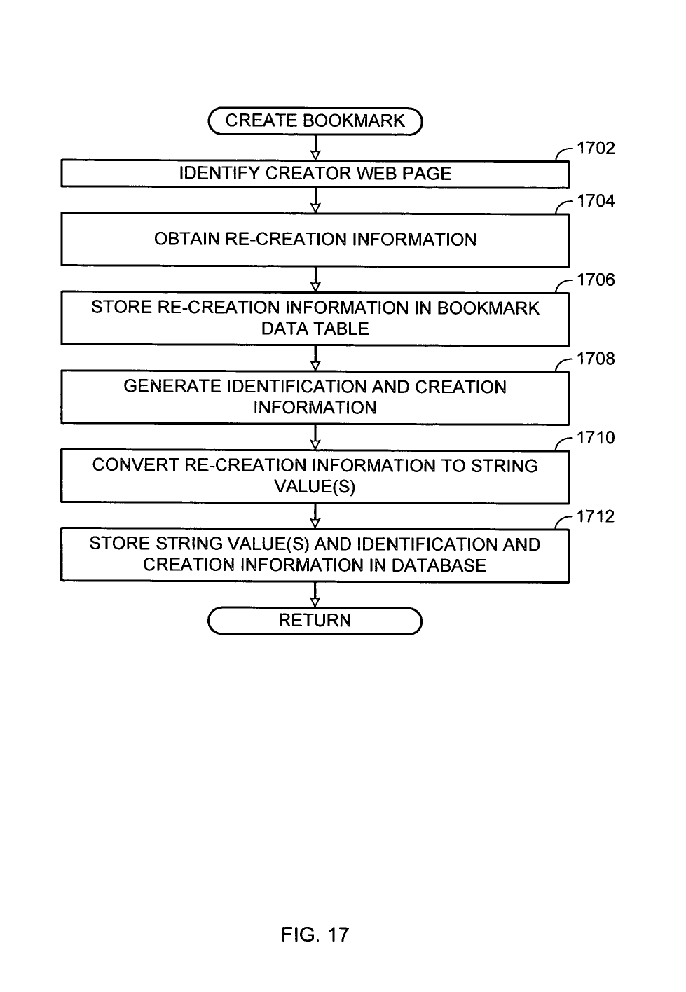

Now turning in detail to the flowchart of FIG. 13, during operation the OSF data file generator 202 (FIG. 2) generates one or more of the plurality of OSF data files 208 (FIG. 2) (block 1302). An example method or process that may be used to implement the operation of block 1302 is described below in connection with FIG. 14. After one or more of the plurality of OSF data files 208 are generated, the OSF data file interface 204 (FIG. 2) retrieves user-requested process control log information (block 1304) from one or more of the plurality of OSF data files 208. An example method or process that may be used to implement the operation of block 1304 is described below in connection with FIG. 15. A user can then navigate through the process control log information using a web-based interface (block 1306) such as, for example, the web-based user interface 900 of FIGS. 9, 10A, and 10B. An example method or process that may be used to implement the operation of the operation of block 1306 is described below in connection with FIGS. 16A, 16B, and 17.

FIG. 14 is a flowchart illustrating an example method that may be used to generate an OSF data file (e.g., one of the OSF data files 208 of FIG. 2). The flowchart of FIG. 14 may be used to implement the operation of block 1302 described above in connection with FIG. 13. Initially, the OSF data file generator 204 obtains a data collection command (block 1402). For example, the time period specifier 212 (FIG. 2) obtains a data collection command from the administrator 210 (FIG.2). The time period specifier 212 (FIG. 2) then determines a data logging time period (block 1404). For example, the time period specifier 212 may retrieve a data logging time period from the data collection command or may determine a data logging time period based on a clock and/or a value stored in a register as described above in connection with FIG. 2.

The data queries interface 214 (FIG. 2) then communicates a data query to the log database 206 (FIG. 2) (block 1406). For example, the data queries interface 214 may obtain the data logging time period from the time period specifier 212 and form a data query based on the data logging time period and a base query string described above in connection with FIG. 2 and communicate the data query to the log database 206 to retrieve process control log information logged in the log database 206 during the specified data logging time period. The data queries interface 214 then obtains the process control log information from the log database 206 (block 1408) and the data processor 216 categorizes and summarizes the process control log information (block 1410) to generate the data type category segments 218 (FIG. 2). For example, the data queries interface 214 may communicate the process control log information to the data processor 216 and the data processor may analyze each process control log information entry to determine into which data type category (e.g., an alarm category, a user actions category, a module errors category, a system category, a log alarm category, a log event category, a remaining category, etc.) it should be categorized. The data processor 216 may also summarize the process control log information by generating total count values for the instance/condition log entries in each data type category, for the overall number of instance/condition log entries, or any other type of log entry count (e.g., the TotCnt parameter 712, the Cnt1 parameter 714 of FIG. 7, etc.).

The OSF data file formatter 220 (FIG. 2) then writes the categorized and summary information to one of the OSF data files 208 (FIG. 2) (block 1412) and stores the OSF data file 208 (block 1414). For example, the OSF data file formatter 220 may obtain the categorized process control log information and summary information generated at block 1410 from the data type category segments 218 and write the categorized and summary information to one of the OSF data files 208 based on one of the example daily or monthly data file formats 300 and 400 described above in connection with FIGS. 3 and 4. If an OSF data file for the data logging time period specified at block 1404 has not yet been created, then the OSF data file formatter 220 creates one of the OSF data files 208 before writing the categorized and summary information to the OSF data file 208. After the OSF data file formatter 220 stores the OSF data file 208 in, for example, the memory 222 (FIG. 2), the example method or process of FIG. 14 returns control to a calling function or process such as, for example, the example method of FIG. 13.

FIG. 15 is a flowchart illustrating an example method that may be used to retrieve user-requested process control log information from an OSF data file using the OSF data file interface 204 of FIG. 2. The flowchart of FIG. 15 may be used to implement the operation of block 1304 described above in connection with FIG. 13. Initially, the OSF data file interface 204 obtains the user request 224 (FIG. 2) (block 1502). For example, after a user submits a request via, for example, the web-based user interface 900 of FIGS. 9, 10A, and 10B, the time period identifier 226 (FIG. 2) and the requested information identifier 228 (FIG. 2) obtain the user request 224. The time period identifier 226 then determines a data logging time period (block 1504) associated with the user request 224. For example, the time period identifier 226 may retrieve or extract from the user request 224 the data logging time period associated with the process control log information that the user requested via the web-based user interface 900. The data logging time period may specify, for example, a month or a day data logging time period and a date (e.g., month/day/year or month/year).

The requested information identifier 228 then determines the type of process control log information that the user requested (block 1506) based on the user request 224. For example, the requested information identifier 228 may extract, identify, or otherwise obtain from the user request 224 which type of process control log information the user requested via the web-based user interface 900. The file reader 230 (FIG. 2) then retrieves one of the OSF data files 208 based on the data logging time period (block 1508) determined at block 1504 and reads the process control log information stored in the retrieved OSF data file (block 1510).

The data filter 232 then filters the process control log information (block 1512) read from one of the OSF data files 208 at block 1510. For example, the data filter 232 may obtain one or more values, strings, or otherwise messages from the requested information identifier 228 describing the type of process control log information indicated in the user requested 224 and select one or more data filters to use to extract or obtain the requested type of process control log information from the process control log information received from the file reader 230. The data analyzer 234 and the pre-processor 236 of FIG. 2 then analyze and pre-process the filtered process control log information (block 1514). For example, the data analyzer 234 may generate count values, statistical values, interval time values between occurrences of particular instances or conditions, or generate any other type of analytical value associated with the particular process control log information filtered by the data filter 232. The pre-processor 236 may determine other count values or statistical information associated with the filtered process control log information or may obtain count values (e.g., the TotCnt parameter 712 or the Cnt1 parameter 714 of FIG. 7) from the file reader 230. The pre-processor 236 may also organize the filtered process control log information based on, for example, data category, summary information, detailed information, analysis information, etc. to generate the plurality of pre-processed information segments 238 (FIG. 2).

The post-processor 240 (FIG. 2) then organizes and labels the filtered process control log information (block 1516) to produce the processed information 242 and outputs the processed information 242 (FIG. 2) (block 1518). For example, the post-processor 240 may obtain the filtered process control log information and any other information or values (e.g., count values, statistical values, etc.) generated based on the filtered process control log information and organize all of the information into tables, columns, rows, or any other type of organization. The post-processor 240 may then assign text identifiers, text descriptions, text strings, etc. (e.g., the data descriptions 502 and/or the data category descriptions 602 of FIGS. 5 and 6) to tags (e.g., the tags 504 and 604 of FIGS. 5 and 6) associated with the process control log information by, for example, replacing each of the tags with a respective description or label. The post-processor 240 may output the process information 242 to a client application, a web-based application (e.g., the web-based user interface 900 of FIGS. 9, 10A, and 10B), a storage medium, or to any other user-specified destination. The example method or process of FIG. 15 then returns control to a calling function or process such as, for example, the example method of FIG. 13.

FIGS. 16A and 16B depict a flowchart illustrating an example method that may be used to navigate through process control log information using, for example, the web-based user interface 900 of FIGS. 9, 10A, and 10B in combination with the OSF data file interface 204 (FIG. 2). For example, the web-based user interface 900 may communicate user requests (e.g., the user request 224 of FIG. 2) to the OSF data file interface 204 via the web application 1100 of FIGS. 11 and 12 to retrieve requested process control log information from the OSF data files 208 (FIG. 2). The flowchart of FIGS. 16A and 16B may be used to implement the operation of block 1306 described above in connection with FIG. 13. Initially, the web-based user interface 900 displays summary information associated with process control log information requested by a user (block 1602). For example, the web-based user interface 900 may display summary information using text and/or graphics as shown in FIG. 9. The web application 1100 then assigns an index number to the currently displayed web page (block 1604) showing the summary information. For example, the web application 1100 assigns an index number zero to the currently displayed web page as described above in connection with FIG. 12.

The web application 1100 then determines if it should create a bookmark (e.g., a favorites hyperlink) (block 1606). For example, the web application 1100 may determine that it should create a bookmark if it receives user-input from the web-based user interface 900 indicating that a user has requested to create a bookmark. If the web application 1100 determines that it should create a bookmark, then the web application 1100 creates a bookmark (block 1608). An example method that may be used to create a bookmark is described below in connection with FIG. 17. After creating the bookmark at block 1608 or if the web application 1100 determines at block 1606 that it should not create a bookmark, then the web application 1100 determines if it should navigate to a new web page (block 1610). For example, the web application 1100 may determine that it should navigate to a new web page if it receives user-input (e.g., a request, a command, etc.) from the web-based user interface 900 indicating that a user has, for example, entered a new web address or selected a hyperlink associated with navigating to a new web page (e.g., loading or displaying a new web page).

If the web application 1100 determines that it should not navigate to a new web page, then the web application 1100 determines if it has received a request for detailed information (e.g., the instrument alarm information in the detailed information area of 1006 of FIG. 10B) (block 1612). For example, the web application 1100 may determine that it has received a request for detailed information if it receives user-input from the web-based user interface 900 indicating that a user has, for example, entered a request for detailed information or selected a hyperlink (e.g., the pie chart portion 1004 of FIG. 10A) associated with obtaining detailed information. If the web application 1100 determines that it has received a request for detailed information then the web application 1100 displays the requested detailed process control information (block 1614). For example, the web application 1100 may communicate the user request 224 (FIG. 2) to the OSF data file interface 204 (FIG. 2) requesting the detailed process control information requested by a user via the web-based user interface 900. The OSF data file interface 204 may then obtain the requested detailed process control information from one of the OSF data files 208 (FIG. 2) as described above in connection with the example method of FIG. 15 and communicate the requested detailed process control information to the web application 1100. The web application 1100 then displays the requested detailed process control information via the web-based user interface 900 in, for example, the detailed information area 1006 described above in connection with FIG. 10B. After the web application 1100 displays the requested detailed process control log information or if the web application 1100 determines at block 1612 that is has not received a request for detailed information, then the control is passed back to block 1606.

If at block 1610 the web application 1100 determines that it should navigate to a new web page, then the web application 1100 increments the index value of the currently loaded web page (block 1616) as described above in connection with FIG. 12. For example, the web application 1100 may increment the index value of the currently loaded web page from index value zero to index value one. The web application 1100 then stores in an index table (e.g., the index table 1210 of FIG. 12) any information changed in the currently loaded web page (block 1618). For example, the web application 1100 may store the changed information in a table entry associated with the index value of the currently loaded web page as described above in connection with FIG. 12. The web application 1100 then assigns an index value zero to the new web page (e.g., the web page 1212a of FIG. 12) (block 1620) and displays the new web page (block 1622).

As shown in FIG. 16B, the web application 1100 then determines if it should navigate to a previous web page (e.g., the web page 1212b of FIG. 12) (block 1624). For example, the web application 1100 may determine that it should navigate to a previous web page if it obtains user-input associated with the backward control 1204 (FIG. 12) indicating that a user requested to view a previous web page. Alternatively, if the web application 1100 is displaying a previously displayed web page having an index value of, for example, one or greater, the web application may additionally determine that it should navigate to a previous web page (e.g., a web page associated with a lower index value) if it obtains user-input associated with the forward control 1202. In any case, if the web application 1100 determines at block 1624 that it should display or navigate to a previous web page, then the web application 1100 stores in an index table (e.g., the index table 1210 of FIG. 12) any information changed in the currently loaded web page (block 1626) as described above in connection with FIG. 12 and the operation of block 1618. The web application 1100 then obtains the index value of the previous web page (block 1628) to be displayed. For example, the web application 1100 may obtain the index value of the currently loaded web page from a register or variable and add one to that index value.

The web application 1100 then obtains changed information from the index table 1210 (block 1630) based on the index value of the previous web page obtained at block 1628. The changed information retrieved from the index table 1210 is information previously stored in the index table 1210 by the web application 1100 using, for example, the operation of block 1618. The web application 1100 then retrieves from a server (e.g., the server 1102) any non-changed information associated with the previous web page (block 1632) that is not stored in the index table 1210. For example, after populating data fields of the previous web page with the changed information retrieved from the index table 208, the web application 1100 determines if any remaining data fields of the previous web page have not been populated with data. The web application 1100 then determines that those data fields not yet populated are associated with information that the user did not change when the previous web page was previously loaded or displayed and, thus, retrieves from the server 1102 the information associated with the data fields not yet populated. The web application 1100 then displays the previous web page with the changed and non-changed information (block 1634). The web application 1100 then determines if it should be closed (block 1636) based on, for example, user input or a command indicating that the web application 1100 should be closed. If the web application 1100 has not received user input or a command to close, then control is returned to block 1606. Otherwise, the example method or process of FIGS. 16A and 16B returns control to a calling function or process such as, for example, the example method of FIG. 13.

FIG. 17 is a flowchart illustrating an example method that may be used to create a bookmark associated with web pages having dynamic information. The example method of FIG. 17 may be used to implement the operation of block 1608 described above in connection with FIG. 16A. Initially, the web application 1100 (FIG. 11) identifies a creator web page (block 1702). For example, if the web application 1100 creates a bookmark for the web page displayed by the web-based user interface 900 as shown in FIG. 10B displaying the detailed information area 1006, the web application 1100 determines that the creator web page is the web page displayed by the web-based user interface 900 as shown in FIG. 10A. The web application 1100 then obtains re-creation information (block 1704) associated with re-creating the web page to be bookmarked. For example, if the web page to be bookmarked is the web page shown in FIG. 10B, the re-creation information may be, for example, a data logging time period, data type categories associated with the displayed process control log information, the selection of the pie chart portion 1004 shown in FIG. 10A that causes the detailed information area 1006 (FIG. 10B) to be displayed, and any other parameters or information required for the creator web page to retrieve the process control log information from the OSF data file interface 204 and re-create the bookmarked web page.

The web application 1100 then stores the re-creation information in a bookmark data table (e.g., the bookmark data table 1112 of FIG. 11) (block 1706) as described above in connection with FIG. 11. The web application 1100 then generates identification and creation information (block 1708) associated with the bookmark being created. For example, the web application 1100 may generate the identification and creation information 1118 described above in connection with FIG. 11. The web application 1100 then converts the re-creation information to one or more string values (block 1710) and stores the string values and the identification and creation information in a database (block 1712). For example, the web application 1100 may retrieve the re-creation information from the bookmark data table 1112 and convert the re-creation information to the data table strings 1116 (FIG. 11). The web application 1100 can then store the identification and creation information 1118 and the data table strings 1116 in the database 1114 as described above in connection with FIG. 11.

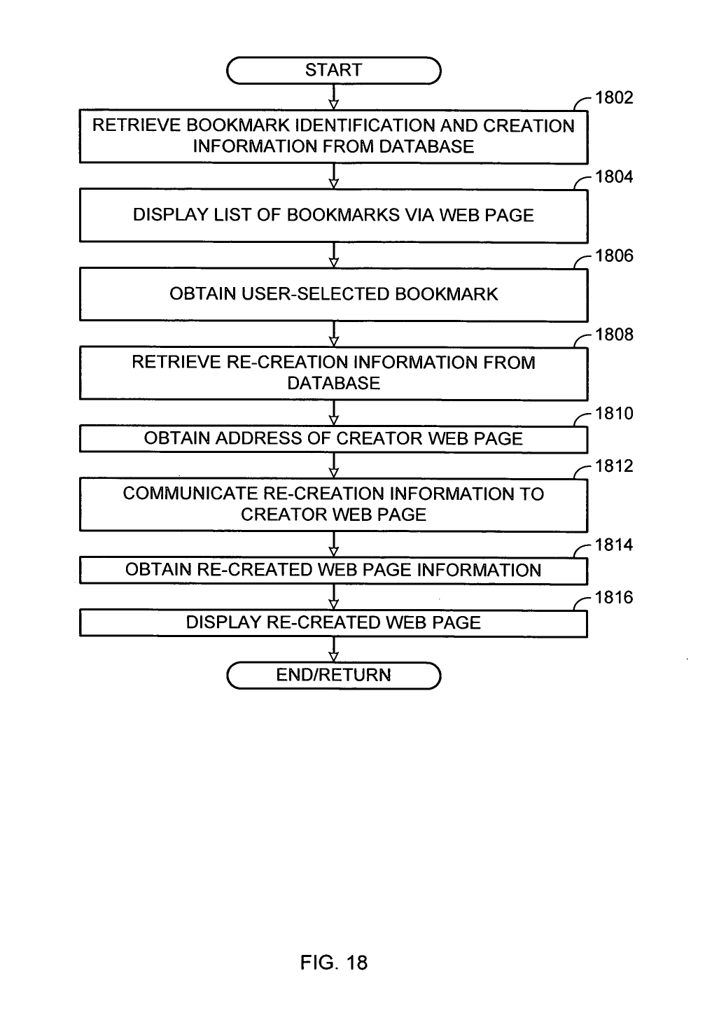

FIG. 18 is a flowchart illustrating an example method that may be used to re-create a web page having dynamic information from a bookmark created using the example method of FIG. 17. The example method of FIG. 18 may be implemented using the web application 1100 of FIG. 11. Initially, the web application 1100 retrieves identification and creation information (e.g., the identification and creation information 1118 of FIG. 11) from the database 1114 (FIG. 11) (block 1802) and displays a list of bookmarks via a web page (block 1804). For example, the web application 1100 may generate the list of bookmarks based on the retrieved identification and creation information and display the list of bookmarks via the user interface 1108 (FIG. 11).

The web application 1100 then retrieves a user-selected bookmark (block 1806) and retrieves the re-creation information associated with the user-selected bookmark from the database 1114 (block 1808). For example, the web application 1100 may obtain user input indicating which of the bookmarks displayed via the user interface 1108 a user has selected. The web application 1100 may then retrieve one or more data table strings (e.g., the data table strings 1116 of FIG. 11) containing the re-creation information associated with the selected bookmark from the database 1114 based on the identification and creation information (e.g., the identification and creation information 1118) of the selected bookmark.

The web application 1100 then obtains the address (e.g., a URL address) of the creator web page (block 1810) associated with the selected bookmark. For example, the web application 1100 may obtain the address of the creator web page from the identification and creation information 1118. After obtaining the creator web page address, the web application 1100 communicates the re-creation information retrieved at block 1808 to the creator web page (block 1812). In this manner, the creator web page can re-create or dynamically generate the bookmarked web page based on the re-creation information. The web application 1100 then obtains the re-created web page information (block 1814) and displays the re-created web page (block 1816). For example, if the creator web page is hosted by the server 1102 (FIG. 11), the web application 1100 may obtain the re-created web page information from the server 1102. The web application 1100 may then display the re-created web page via the user interface 1108. The example method or process of FIG. 18 is then ended or control is returned to a calling function or process.

FIG. 19 is a block diagram of an example processor system that may be used to implement the example apparatus, methods, and articles of manufacture described herein. As shown in FIG. 19, the processor system 1910 includes a processor 1912 that is coupled to an interconnection bus 1914. The processor 1912 includes a register set or register space 1916, which is depicted in FIG. 19 as being entirely on-chip, but which could alternatively be located entirely or partially off-chip and directly coupled to the processor 1912 via dedicated electrical connections and/or via the interconnection bus 1914. The processor 1912 may be any suitable processor, processing unit or microprocessor. Although not shown in FIG. 19, the system 1910 may be a multi-processor system and, thus, may include one or more additional processors that are identical or similar to the processor 1912 and that are communicatively coupled to the interconnection bus 1914.

The processor 1912 of FIG. 19 is coupled to a chipset 1918, which includes a memory controller 1920 and an input/output (I/O) controller 1922. As is well known, a chipset typically provides I/O and memory management functions as well as a plurality of general purpose and/or special purpose registers, timers, etc. that are accessible or used by one or more processors coupled to the chipset 1918. The memory controller 1920 performs functions that enable the processor 1912 (or processors if there are multiple processors) to access a system memory 1924 and a mass storage memory 1925.

The system memory 1924 may include any desired type of volatile and/or non-volatile memory such as, for example, static random access memory (SRAM), dynamic random access memory (DRAM), flash memory, read-only memory (ROM), etc. The mass storage memory 1925 may include any desired type of mass storage device including hard disk drives, optical drives, tape storage devices, etc.

The I/O controller 1922 performs functions that enable the processor 1912 to communicate with peripheral input/output (I/O) devices 1926 and 1928 and a network interface 1930 via an I/O bus 1932. The I/O devices 1926 and 1928 may be any desired type of I/O device such as, for example, a keyboard, a video display or monitor, a mouse, etc. The network interface 1930 may be, for example, an Ethernet device, an asynchronous transfer mode (ATM) device, an 802.11 device, a DSL modem, a cable modem, a cellular modem, etc. that enables the processor system 1910 to communicate with another processor system.

While the memory controller 1920 and the I/O controller 1922 are depicted in FIG. 19 as separate functional blocks within the chipset 1918, the functions performed by these blocks may be integrated within a single semiconductor circuit or may be implemented using two or more separate integrated circuits.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method of accessing process control log information, comprising:
obtaining the process control log information from a database based on a plurality of logging time periods and at least one data query;
categorizing the process control log information based on at least one of a plurality of categories;
generating a plurality of output files based on the plurality of logging time periods and the categorized process control log information;
retrieving a portion of the process control log information from one of the plurality of output files based on one of the plurality of logging time periods; and
outputting the portion of the process control log information.

2. A method as defined in claim 1 further comprising determining the plurality of logging time periods based on present time values.

3. A method as defined in claim 1, wherein the plurality of logging time periods are associated with at least one of a day time period and a month time period.

4. A method as defined in claim 1, wherein the plurality of categories includes at least one of an alarms category, a user actions category, a system events category, a module errors category, a log alarms category, and a log events category.

5. A method as defined in claim 1, wherein the output file includes extensible markup language.

6. A method as defined in claim 1 further comprising obtaining a user request associated with obtaining the portion of the process control log information, wherein the user request indicates at least one of the plurality of logging time periods and at least one of the plurality of categories.

7. A method as defined in claim 1, wherein outputting the portion of the process control log information comprises at least one of outputting the portion of the process control log information via a web browser user interface and a client application user interface.

8. A method of generating web browser session history, comprising:
assigning a first index value to a first web page;
obtaining a request associated with loading a second web page;
incrementing the first index value;
storing changed information associated with the first web page in a table based on the first index value; and
assigning a second index value to the second web page.

9. A method as defined in claim 8 further comprising:
obtaining a request associated with loading the first web page;
obtaining the first index value;
retrieving the changed information from the table based on the first index value; and
displaying the change information and the first web page.

10. A method as defined in claim 8, wherein the changed information is associated with information provided via input fields of the first web page.

11. A method of generating a bookmark for a dynamic web page, comprising:
identifying a web page displaying first information;
obtaining second information associated with displaying third information via the web page, wherein the second information is provided to a web application via the web page to display the third information; and
storing the second information in a database.

12. A method as defined in claim 11, wherein the web application is a server-side web application.

13. A method as defined in claim 11, wherein the web page displaying the first information is a creator web page, and wherein the web page displaying the third information is a dynamic web page.

14. A method as defined in claim 11 further comprising displaying the third information by:
obtaining the second information from the database;
obtaining an address associated with the web page; and
generating the third information via the web page based on the second information and the address.
